(19) United States
(12) Patent Application Publication
(10) Pub. No.: US 2026/0257106 A1
(43) Pub. Date: Sep. 3, 2026

(54) STREAMING-BASED ARTIFICIAL INTELLIGENCE FITNESS SYSTEM WITH REAL TIME BIOMETRIC SENSING

(71) Applicants: Daniel McDermott, College Grove, TN (US); Rachel McDermott, College Grove, TN (US)

(72) Inventors: Daniel McDermott, College Grove, TN (US); Rachel McDermott, College Grove, TN (US)

(21) Appl. No.: 19/443,792

(22) Filed: Jan. 8, 2026

(51) Int. Cl. A63B 24/00; A63B 71/06; G06N 20/00

(52) U.S. Cl. CPC A63B 24/0075; A63B 24/0006; A63B 24/0062; A63B 71/0622; G06N 20/00; A63B 2024/0065; A63B 2071/0638; A63B 2071/0647; A63B 2230/015; A63B 2230/062; A63B 2230/201; A63B 2230/505

(57) ABSTRACT

The present disclosure provides an automatic coaching system comprising a first computing device with a user interface managing user permission levels, biometric sensors measuring the user's physical condition data, input devices collecting user data, a second computing device hosting virtual environments and machine learning techniques that receives biometric and input data from the first device, a display showing virtual world images, a processor connecting all components, and a non-transitory computer-readable medium with instructions for receiving biometric and input data, transforming it into fitness data with a virtual user model having biometric attributes, coupling fitness data with the user's training plan, generating training instructions, and presenting instructions via the display.

### FIELD OF INVENTION

The present disclosure relates to streaming-based interactive application systems for resource-constrained devices, and more particularly to a system that combines cloud application streaming with centralized database-driven content management and real-time artificial intelligence integration for deploying sophisticated fitness and training applications to devices with limited processing capabilities.

### BACKGROUND

Modern fitness and training applications increasingly demand sophisticated interactive experiences that can adapt to user performance in real-time. Traditional fitness equipment and training devices typically operate with limited processing capabilities, constraining their ability to deliver advanced graphical interfaces and intelligent coaching systems. Many commercial fitness machines, educational devices, and medical equipment rely on basic embedded processors with minimal memory resources, making it challenging to implement complex interactive applications locally. The deployment of high-quality graphics, physics simulations, and artificial intelligence features to such resource-constrained devices presents significant technical obstacles. Current solutions often require expensive proprietary hardware upgrades or result in severely compromised user experiences when attempting to run sophisticated applications on standard equipment. These limitations create barriers to delivering premium interactive training experiences across diverse hardware platforms.

Biometric monitoring systems face substantial challenges in collecting, processing, and responding to physiological data from users during physical activities. Contemporary wearable devices and fitness sensors generate continuous streams of biometric information, including heart rate, movement patterns, and performance metrics, but the effective utilization of this data remains problematic. Traditional approaches typically process biometric information locally on user devices, which limits the complexity of analysis algorithms that can be applied to the collected data. Many consumer devices lack sufficient computational resources to implement advanced machine learning techniques for interpreting physiological signals and generating meaningful insights. The integration of multiple biometric data sources from different manufacturers and protocols adds additional complexity to system design. These technical constraints result in underutilized biometric data and missed opportunities for providing personalized guidance to users.

Content management and distribution systems for interactive applications struggle with the challenge of maintaining consistency across multiple deployment instances while enabling rapid updates. Traditional application architectures require complete rebuilds and redistribution processes when content modifications are needed, resulting in significant delays and bandwidth consumption. Multi-instance deployments, such as those found in commercial fitness facilities or educational institutions, often suffer from version inconsistencies and synchronization problems. The coupling of application logic with content data makes it difficult for non-technical content creators to update training programs, coaching scripts, or system parameters without developer intervention. Current streaming platforms and cloud gaming services typically rely on per-instance configuration files, which complicate centralized content management and create opportunities for configuration drift across deployments.

The aforementioned technological challenges have resulted in an environment in which artificial intelligence integration in fitness and training applications remains limited by computational constraints and inflexible system architectures. Machine learning techniques for generating personalized coaching instructions and adaptive responses require substantial processing power that exceeds the capabilities of typical consumer devices and embedded systems. Existing AI coaching systems often provide generic recommendations rather than contextually aware guidance that responds to real-time user performance and environmental conditions. The integration of natural language processing, text-to-speech synthesis, and conversational AI into interactive applications typically involves hardcoded implementations that lock systems into specific service providers. Current approaches fail to effectively leverage centralized computing resources to overcome device limitations while maintaining responsive user interactions. These barriers prevent the development of more sophisticated AI-driven coaching systems that can provide truly personalized and adaptive training experiences.

### SUMMARY

A system and method for integrating biometric sensor data into real-time streaming artificial intelligence coaching is provided. In one aspect, the present invention is a medical analysis tool providing specialized, artificial intelligence-produced feedback to patients undergoing physical therapy. In another aspect, the present invention is a cost-saving tool for physical education that facilitates monitoring and training multiple students. In yet another aspect, the present invention is a responsive training method for fitness-focused professionals like soldiers, sailors, and professional athletes. In still another aspect, the present invention is a personal training aid that supplements or replaces the coaching of a personal trainer. Generally, the present invention retrieves biometric data from a user, processes it in a central server, generates coaching instructions via a machine learning technique, and relays them to a user device.

The system operates through a streaming-based architecture that enables deployment of sophisticated interactive applications to resource-constrained devices while maintaining centralized database-driven content management. Interactive applications execute on high-performance servers equipped with advanced graphics processing units and substantial memory resources, then stream rendered video and audio output to client devices via network protocols such as WebRTC or custom streaming implementations. Client devices require only basic video decode capability, input transmission functionality, and sensor data relay capacity, allowing deployment to fitness equipment with minimal ARM processors, budget educational tablets, medical equipment touchscreens, and point-of-sale terminals. The centralized database stores complete application behavioral logic as structured data rather than compiled code, enabling instant content updates without application rebuilds or redistribution. Real-time application state information automatically translates into natural language descriptions that provide contextual awareness to artificial intelligence systems. This architecture combines cloud computing power with database-driven flexibility to overcome hardware limitations while maintaining responsive user interactions.

The system is configured to extract real-time application metrics from sensors about the user, including user performance data, environmental conditions, and session history, to generate contextually appropriate coaching responses. The system merges structured templates with generative artificial intelligence to produce varied dialogue while maintaining consistent character personalities across interactions. The system employs weighted probabilistic selection mechanisms that control content variety through multi-tier weighting systems including sentence length selection, category distribution, and context-based filtering. Universal service provider integration enables switching between different artificial intelligence models, text-to-speech services, and analytics platforms through database configuration changes without code modifications. External device integration accommodates wearable sensors, heart rate monitors, and fitness equipment through database-stored threshold parameters and response protocols. These components work together to create adaptive coaching experiences that respond to real-time user data while maintaining system flexibility and scalability across diverse hardware deployments.

The foregoing summary has outlined some features of the system and method of the present disclosure so that those skilled in the pertinent art may better understand the detailed description that follows. Additional features that form the subject of the claims will be described hereinafter. Those skilled in the pertinent art should appreciate that they can readily utilize these features for designing or modifying other structures for carrying out the same purpose of the system and method disclosed herein. Those skilled in the pertinent art should also realize that such equivalent designs or modifications do not depart from the scope of the system and method of the present disclosure.

### BRIEF DESCRIPTION OF FIGURES

These and other features, aspects, and advantages of the present disclosure will become better understood with regard to the following description, appended claims, and accompanying drawings where:

FIG. 1 illustrates a network environment embodying features consistent with the principles of the present disclosure.

FIG. 2 illustrates a computing device embodying features consistent with the principles of the present disclosure.

FIG. 3 illustrates a computing device embodying features consistent with the principles of the present disclosure.

FIG. 4 illustrates a system embodying features consistent with the principles of the present disclosure.

FIG. 5 illustrates a user device and fitness equipment utilizing a system and method consistent with the principles of the present disclosure.

FIG. 6 illustrates a plurality of user sensors consistent with the principles of the present disclosure.

FIG. 7 illustrates environments appropriate for using a system consistent with the principles of the present disclosure.

FIG. 8 illustrates the manner in which individual access to data may be granted or limited based on user roles and administrator roles consistent with the principles of the present disclosure.

FIG. 9 illustrates a flow diagram describing a method consistent with the principles of the present disclosure.

### DETAILED DESCRIPTION

In the Summary above and in this Detailed Description, and the claims below, and in the accompanying drawings, reference is made to particular features, including method steps, of the invention. It is to be understood that the disclosure of the invention in this specification includes all possible combinations of such particular features. For instance, where a particular feature is disclosed in the context of a particular aspect or embodiment of the invention, or a particular claim, that feature can also be used, to the extent possible, in combination with/or in the context of other particular aspects of the embodiments of the invention, and in the invention generally.

The term “comprises”, and grammatical equivalents thereof are used herein to mean that other components, steps, etc. are optionally present. For instance, a system “comprising” components A, B, and C can contain only components A, B, and C, or can contain not only components A, B, and C, but also one or more other components. Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility). As will be evident from the disclosure provided below, the present invention satisfies the need for a system and method capable of managing fitness of its users.

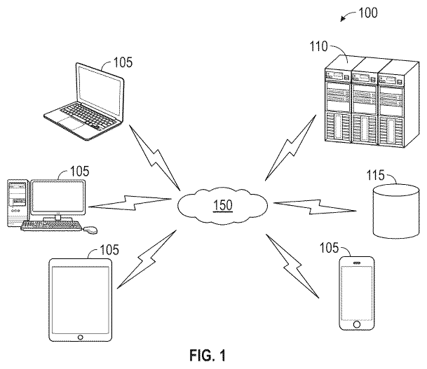

FIG. 1 depicts an exemplary environment 100 of the system 400 consisting of clients 105 connected to a server 110 and/or database 115 via a network 150. Clients 105 are devices of users 405 that may be used to access servers 110 and/or databases 115 through a network 150. A network 150 may comprise of one or more networks of any kind, including, but not limited to, a local area network (LAN), a wide area network (WAN), metropolitan area networks (MAN), a telephone network, such as the Public Switched Telephone Network (PSTN), an intranet, the Internet, a memory device, another type of network, or a combination of networks. In a preferred embodiment, computing entities 200 may act as clients 105 for a user 405. For instance, a client 105 may include a personal computer, a wireless telephone, a streaming device, a “smart” television, a personal digital assistant (PDA), a laptop, a smart phone, a tablet computer, or another type of computation or communication interface 280. Servers 110 may include devices that access, fetch, aggregate, process, search, provide, and/or maintain documents. Although FIG. 1 depicts a preferred embodiment of an environment 100 for the system 400, in other implementations, the environment 100 may contain fewer components, different components, differently arranged components, and/or additional components than those depicted in FIG. 1. Alternatively, or additionally, one or more components of the environment 100 may perform one or more other tasks described as being performed by one or more other components of the environment 100.

As depicted in FIG. 1, one embodiment of the system 400 may comprise a server 110. Although shown as a single server 110 in FIG. 1, a server 110 may, in some implementations, be implemented as multiple devices interlinked together via the network 150, wherein the devices may be distributed over a large geographic area and performing different functions or similar functions. For instance, two or more servers 110 may be implemented to work as a single server 110 performing the same tasks. Alternatively, one server 110 may perform the functions of multiple servers 110. For instance, a single server 110 may perform the tasks of a web server and an indexing server 110. Additionally, it is understood that multiple servers 110 may be used to operably connect the processor 220 to the database 115 and/or other content repositories. The processor 220 may be operably connected to the server 110 via wired or wireless connection. Types of servers 110 that may be used by the system 400 include, but are not limited to, search servers, document indexing servers, and web servers, or any combination thereof.

Search servers may include one or more computing entities 200 designed to implement a search engine, such as a documents/records search engine, general webpage search engine, etc. Search servers may, for instance, include one or more web servers designed to receive search queries and/or inputs from users 405, search one or more databases 115 in response to the search queries and/or inputs, and provide documents or information, relevant to the search queries and/or inputs, to users 405. In some implementations, search servers may include a web search server that may provide webpages to users 405, wherein a provided webpage may include a reference to a web server at which the desired information and/or links are located. The references to the web server at which the desired information is located may be included in a frame and/or text box, or as a link to the desired information/document. Document indexing servers may include one or more devices designed to index documents available through networks 150. Document indexing servers may access other servers 110, such as web servers that host content, to index the content. In some implementations, document indexing servers may index documents/records stored by other servers 110 connected to the network 150. Document indexing servers may, for instance, store and index content, information, and documents relating to user accounts and user-generated content. Web servers may include servers 110 that provide webpages to clients 105. For instance, the webpages may be HTML-based webpages. A web server may host one or more websites. As used herein, a website may refer to a collection of related webpages. Frequently, a website may be associated with a single domain name, although some websites may potentially encompass more than one domain name. The concepts described herein may be applied on a per-website basis. Alternatively, in some implementations, the concepts described herein may be applied on a per-webpage basis.

As used herein, a database 115 refers to a set of related data and the way it is organized. Access to this data is usually provided by a database management system (DBMS) consisting of an integrated set of computer software that allows users 405 to interact with one or more databases 115 and provides access to all of the data contained in the database 115. The DBMS provides various functions that allow entry, storage and retrieval of large quantities of information and provides ways to manage how that information is organized. Because of the close relationship between the database 115 and the DBMS, as used herein, the term database 115 refers to both a database 115 and DBMS.

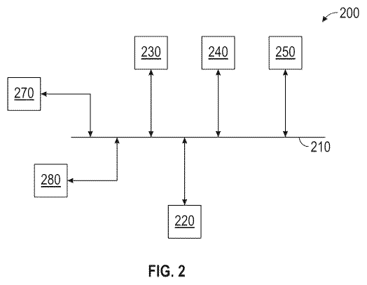

FIG. 2 is an exemplary diagram of a client 105, server 110, and/or or database 115 (hereinafter collectively referred to as “computing entity 200”), which may correspond to one or more of the clients 105, servers 110, and databases 115 according to an implementation consistent with the principles of the invention as described herein. The computing entity 200 may comprise a bus 210, a processor 220, memory 304, a storage device 250, a peripheral device 270, and a communication interface 280 (such as wired or wireless communication device). The bus 210 may be defined as one or more conductors that permit communication among the components of the computing entity 200. The processor 220 may be defined as logic circuitry that responds to and processes the basic instructions that drive the computing entity 200. Memory 304 may be defined as the integrated circuitry that stores information for immediate use in a computing entity 200. A peripheral device 270 may be defined as any hardware used by a user 405 and/or the computing entity 200 to facilitate communicate between the two. A storage device 250 may be defined as a device used to provide mass storage to a computing entity 200. A communication interface 280 may be defined as any transceiver-like device that enables the computing entity 200 to communicate with other devices and/or computing entities 200.

The bus 210 may comprise a high-speed interface 308 and/or a low-speed interface 312 that connects the various components together in a way such they may communicate with one another. A high-speed interface 308 manages bandwidth-intensive operations for computing device 300, while a low-speed interface 312 manages lower bandwidth-intensive operations. In some preferred embodiments, the high-speed interface 308 of a bus 210 may be coupled to the memory 304, display 316, and to high-speed expansion ports 310, which may accept various expansion cards such as a graphics processing unit (GPU). In other preferred embodiments, the low-speed interface 312 of a bus 210 may be coupled to a storage device 250 and low-speed expansion ports 314. The low-speed expansion ports 314 may include various communication ports, such as USB, Bluetooth, Ethernet, wireless Ethernet, etc. Additionally, the low-speed expansion ports 314 may be coupled to one or more peripheral devices 270, such as a keyboard, pointing device, scanner, and/or a networking device, wherein the low-speed expansion ports 314 facilitate the transfer of input data from the peripheral devices 270 to the processor 220 via the low-speed interface 312.

The processor 220 may comprise any type of conventional processor or microprocessor that interprets and executes computer readable instructions. The processor 220 is configured to perform the operations disclosed herein based on instructions stored within the system 400. The processor 220 may process instructions for execution within the computing entity 200, including instructions stored in memory 304 or on a storage device 250, to display graphical information for a graphical user interface (GUI) on an external peripheral device 270, such as a display 316. The processor 220 may provide for coordination of the other components of a computing entity 200, such as control of user interfaces 411, applications run by a computing entity 200, and wireless communication by a communication interface 280 of the computing entity 200. The processor 220 may be any processor or microprocessor suitable for executing instructions. In some embodiments, the processor 220 may have a memory device therein or coupled thereto suitable for storing the data, content, or other information or material disclosed herein. In some instances, the processor 220 may be a component of a larger computing entity 200. A computing entity 200 that may house the processor 220 therein may include, but are not limited to, laptops, desktops, workstations, personal digital assistants, servers 110, mainframes, cellular telephones, tablet computers, smart televisions, streaming devices, or any other similar device. Accordingly, the inventive subject matter disclosed herein, in full or in part, may be implemented or utilized in devices including, but are not limited to, laptops, desktops, workstations, personal digital assistants, servers 110, mainframes, cellular telephones, tablet computers, smart televisions, streaming devices, or any other similar device.

Memory 304 stores information within the computing device 300. In some preferred embodiments, memory 304 may include one or more volatile memory units. In another preferred embodiment, memory 304 may include one or more non-volatile memory units. Memory 304 may also include another form of computer-readable medium, such as a magnetic, solid state, or optical disk. For instance, a portion of a magnetic hard drive may be partitioned as a dynamic scratch space to allow for temporary storage of information that may be used by the processor 220 when faster types of memory, such as random-access memory (RAM), are in high demand. A computer-readable medium may refer to a non-transitory computer-readable memory device. A memory device may refer to storage space within a single storage device 250 or spread across multiple storage devices 250. The memory 304 may comprise main memory 230 and/or read only memory (ROM) 240. In a preferred embodiment, the main memory 230 may comprise RAM or another type of dynamic storage device 250 that stores information and instructions for execution by the processor 220. ROM 240 may comprise a conventional ROM device or another type of static storage device 250 that stores static information and instructions for use by processor 220. The storage device 250 may comprise a magnetic and/or optical recording medium and its corresponding drive.

As mentioned earlier, a peripheral device 270 is a device that facilitates communication between a user 405 and the processor 220. The peripheral device 270 may include, but is not limited to, an input device and/or an output device. As used herein, an input device may be defined as a device that allows a user 405 to input data and instructions that is then converted into a pattern of electrical signals in binary code that are comprehensible to a computing entity 200. An input device of the peripheral device 270 may include one or more conventional devices that permit a user 405 to input information into the computing entity 200, such as a controller, scanner, phone, camera, scanning device, keyboard, a mouse, a pen, voice recognition and/or biometric mechanisms, etc. As used herein, an output device may be defined as a device that translates the electronic signals received from a computing entity 200 into a form intelligible to the user 405. An output device of the peripheral device 270 may include one or more conventional devices that output information to a user 405, including a display 316, a printer, a speaker, an alarm, a projector, etc. Additionally, storage devices 250, such as CD-ROM drives, and other computing entities 200 may act as a peripheral device 270 that may act independently from the operably connected computing entity 200. For instance, a streaming device may transfer data to a smartphone, wherein the smartphone may use that data in a manner separate from the streaming device.

The storage device 250 is capable of providing the computing entity 200 mass storage. In some embodiments, the storage device 250 may comprise a computer-readable medium such as the memory 304, storage device 250, or memory 304 on the processor 220. A computer-readable medium may be defined as one or more physical or logical memory devices and/or carrier waves. Devices that may act as a computer readable medium include, but are not limited to, a hard disk device, optical disk device, tape device, flash memory or other similar solid-state memory device, or an array of devices, including devices in a storage area network or other configurations. Examples of computer-readable mediums include, but are not limited to, magnetic media such as hard disks, floppy disks, and magnetic tape; optical media such as CD ROM discs and DVDs; magneto-optical media such as optical discs; and hardware devices that are specially configured to store and perform programming instructions, such as ROM 240, RAM, flash memory, and the like.

In an embodiment, a computer program may be tangibly embodied in the storage device 250. The computer program may contain instructions that, when executed by the processor 220, performs one or more steps that comprise a method, such as those methods described herein. The instructions within a computer program may be carried to the processor 220 via the bus 210. Alternatively, the computer program may be carried to a computer-readable medium, wherein the information may then be accessed from the computer-readable medium by the processor 220 via the bus 210 as needed. In a preferred embodiment, the software instructions may be read into memory 304 from another computer-readable medium, such as data storage device 250, or from another device via the communication interface 280. Alternatively, hardwired circuitry may be used in place of or in combination with software instructions to implement processes consistent with the principles as described herein. Thus, implementations consistent with the invention as described herein are not limited to any specific combination of hardware circuitry and software.

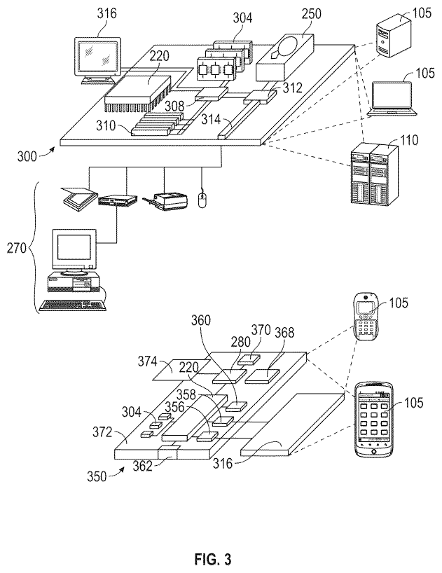

FIG. 3 depicts exemplary computing entities 200 in the form of a computing device 300 and mobile computing device 350, which may be used to carry out the various embodiments of the invention as described herein. A computing device 300 is intended to represent various forms of digital computers, such as laptops, desktops, workstations, servers 110, databases 115, mainframes, and other appropriate computers. A mobile computing device 350 is intended to represent various forms of mobile devices, such as scanners, scanning devices, personal digital assistants, cellular telephones, smart phones, tablet computers, and other similar devices. The various components depicted in FIG. 3, as well as their connections, relationships, and functions are meant to be examples only, and are not meant to limit the implementations of the invention as described herein. The computing device 300 may be implemented in a number of different forms, as shown in FIGS. 1 and 3. For instance, a computing device 300 may be implemented as a server 110 or in a group of servers 110. Computing devices 300 may also be implemented as part of a rack server system. In addition, a computing device 300 may be implemented as a personal computer, such as a desktop computer or laptop computer. Alternatively, components from a computing device 300 may be combined with other components in a mobile device, thus creating a mobile computing device 350. Each mobile computing device 350 may contain one or more computing devices 300 and mobile devices, and an entire system may be made up of multiple computing devices 300 and mobile devices communicating with each other as depicted by the mobile computing device 350 in FIG. 3. The computing entities 200 consistent with the principles of the invention as disclosed herein may perform certain receiving, communicating, generating, output providing, correlating, and storing operations as needed to perform the various methods as described in greater detail below.

In the embodiment depicted in FIG. 3, a computing device 300 may include a processor 220, memory 304 a storage device 250, high-speed expansion ports 310, low-speed expansion ports 314, and bus 210 operably connecting the processor 220, memory 304, storage device 250, high-speed expansion ports 310, and low-speed expansion ports 314. In one preferred embodiment, the bus 210 may comprise a high-speed interface 308 connecting the processor 220 to the memory 304 and high-speed expansion ports 310 as well as a low-speed interface 312 connecting to the low-speed expansion ports 314 and the storage device 250. Because each of the components are interconnected using the bus 210, they may be mounted on a common motherboard as depicted in FIG. 3 or in other manners as appropriate. The processor 220 may process instructions for execution within the computing device 300, including instructions stored in memory 304 or on the storage device 250. Processing these instructions may cause the computing device 300 to display graphical information for a GUI on an output device, such as a display 316 coupled to the high-speed interface 308. In other implementations, multiple processors and/or multiple buses may be used, as appropriate, along with multiple memory units and/or multiple types of memory. Additionally, multiple computing devices may be connected, wherein each device provides portions of the necessary operations.

A mobile computing device 350 may include a processor 220, memory 304 a peripheral device 270 (such as a display 316, a communication interface 280, and a transceiver 368, among other components). A mobile computing device 350 may also be provided with a storage device 250, such as a micro-drive or other previously mentioned storage device 250, to provide additional storage. Preferably, each of the components of the mobile computing device 350 are interconnected using a bus 210, which may allow several of the components of the mobile computing device 350 to be mounted on a common motherboard as depicted in FIG. 3 or in other manners as appropriate. In some implementations, a computer program may be tangibly embodied in an information carrier. The computer program may contain instructions that, when executed by the processor 220, perform one or more methods, such as those described herein. The information carrier is preferably a computer-readable medium, such as memory, expansion memory 374, or memory 304 on the processor 220 such as ROM 240, that may be received via the transceiver or external interface 362. The mobile computing device 350 may be implemented in a number of different forms, as shown in FIG. 3. For instance, a mobile computing device 350 may be implemented as a cellular telephone, part of a smart phone, personal digital assistant, or other similar mobile device.

The processor 220 may execute instructions within the mobile computing device 350, including instructions stored in the memory 304 and/or storage device 250. The processor 220 may be implemented as a chipset of chips that may include separate and multiple analog and/or digital processors. The processor 220 may provide for coordination of the other components of the mobile computing device 350, such as control of the user interfaces 411, applications run by the mobile computing device 350, and wireless communication by the mobile computing device 350. The processor 220 of the mobile computing device 350 may communicate with a user 405 through the control interface 358 coupled to a peripheral device 270 and the display interface 356 coupled to a display 316. The display 316 of the mobile computing device 350 may include, but is not limited to, Liquid Crystal Display (LCD), Light Emitting Diode (LED) display, Organic Light Emitting Diode (OLED) display, and Plasma Display Panel (PDP), holographic displays, augmented reality displays, virtual reality displays, or any combination thereof. The display interface 356 may include appropriate circuitry for causing the display 316 to present graphical and other information to a user 405. The control interface 358 may receive commands from a user 405 via a peripheral device 270 and convert the commands into a computer readable signal for the processor 220. In addition, an external interface 362 may be provided in communication with processor 220, which may enable near area communication of the mobile computing device 350 with other devices. The external interface 362 may provide for wired communications in some implementations or wireless communication in other implementations. In a preferred embodiment, multiple interfaces may be used in a single mobile computing device 350 as is depicted in FIG. 3.

Memory 304 stores information within the mobile computing device 350. Devices that may act as memory 304 for the mobile computing device 350 include, but are not limited to computer-readable media, volatile memory, and non-volatile memory. Expansion memory 374 may also be provided and connected to the mobile computing device 350 through an expansion interface 372, which may include a Single In-Line Memory Module (SIM) card interface or micro secure digital (Micro-SD) card interface. Expansion memory 374 may include, but is not limited to, various types of flash memory and non-volatile random-access memory (NVRAM). Such expansion memory 374 may provide extra storage space for the mobile computing device 350. In addition, expansion memory 374 may store computer programs or other information that may be used by the mobile computing device 350. For instance, expansion memory 374 may have instructions stored thereon that, when carried out by the processor 220, cause the mobile computing device 350 perform the methods described herein. Further, expansion memory 374 may have secure information stored thereon; therefore, expansion memory 374 may be provided as a security module for a mobile computing device 350, wherein the security module may be programmed with instructions that permit secure use of a mobile computing device 350. In addition, expansion memory 374 having secure applications and secure information stored thereon may allow a user 405 to place identifying information on the expansion memory 374 via the mobile computing device 350 in a non-hackable manner.

A mobile computing device 350 may communicate wirelessly through the communication interface 280, which may include digital signal processing circuitry where necessary. The communication interface 280 may provide for communications under various modes or protocols, including, but not limited to, Global System Mobile Communication (GSM), Short Message Services (SMS), Enterprise Messaging System (EMS), Multimedia Messaging Service (MMS), Code Division Multiple Access (CDMA), Time Division Multiple Access (TDMA), Personal Digital Cellular (PDC), Wideband Code Division Multiple Access (WCDMA), IMT Multi-Carrier (CDMAX 0), and General Packet Radio Service (GPRS), or any combination thereof. Such communication may occur, for example, through a transceiver 368. Short-range communication may occur, such as using a Bluetooth, WIFI, or other such transceiver 368. In addition, a Global Positioning System (GPS) receiver module 370 may provide additional navigation-and location-related wireless data to the mobile computing device 350, which may be used as appropriate by applications running on the mobile computing device 350. Alternatively, the mobile computing device 350 may communicate audibly using an audio codec 360, which may receive spoken information from a user 405 and covert the received spoken information into a digital form that may be processed by the processor 220. The audio codec 360 may likewise generate audible sound for a user 405, such as through a speaker, e.g., in a handset of mobile computing device 350. Such sound may include sound from voice telephone calls, recorded sound such as voice messages, music files, etc. Sound may also include sound generated by applications operating on the mobile computing device 350.

The system 400 may comprise a power supply, which may be any source of power that provides the system 400 with the required energy. In a preferred embodiment, the power supply may be a stationary power source that has been installed in a way such that it is fastened in place, such as a 3-prong wall outlet. In a preferred embodiment, the stationary power source is connected to the wiring system of a premises. In another preferred embodiment, the power supply may be a mobile power source, such as a battery pack. In a preferred embodiment, mobile power source does not need to be connected to the wiring system of a premises to provide power to the system but may be capable of connecting to the wiring system of said premises to provide power to a system connected thereto. In another preferred embodiment, the system 400 may comprise multiple power supplies configured to supply power to the system 400 in different circumstances. For instance, the system 400 may be directly plugged into a stationary power source, which may provide power to the system 400 so long as the system does not move out of range of said stationary power source, as well as connected to a mobile power source, which may provide power to the system 400 when the system 400 is not connected to a stationary power source or in situations where the stationary power source ceases to provide power to the system 400.

The system 400 may comprise a power supply, which may be any source of power that provides the system 400 with the required energy. In a preferred embodiment, the power supply may be a stationary power source that has been installed in a way such that it is fastened in place, such as a 3-prong wall outlet. In a preferred embodiment, the stationary power source is connected to the wiring system of a premises, such as a house or a building. In another preferred embodiment, the power supply may be a mobile power source, such as a battery pack, gas-powered generator, and fuel cell. In a preferred embodiment, the mobile power source does not need to be connected to the wiring system of a premises to provide power to the system but may be capable of connecting to the wiring system of said premises to provide power to a system connected thereto. In another preferred embodiment, the system 400 may comprise multiple power supplies configured to supply power to the system 400 in different circumstances. For instance, the system 400 may be directly plugged into a stationary power source, which may provide power to the system 400 so long as the system does not move out of range of said stationary power source, as well as connected to a mobile power source, which may provide power to the system 400 when the system 400 is not connected to a stationary power source or in situations where the stationary power source ceases to provide power to the system 400. In yet another preferred embodiment, a plurality of solar charging panels may be operably connected to a battery of the system, which may then supply power to the system either directly or via the wiring of the premises. As such, the system 400 may be configured to receive power in a variety of ways without departing from the inventive subject matter described herein.

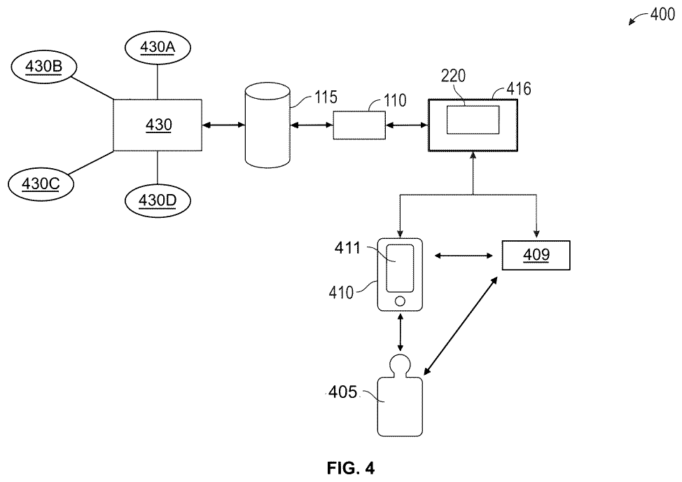

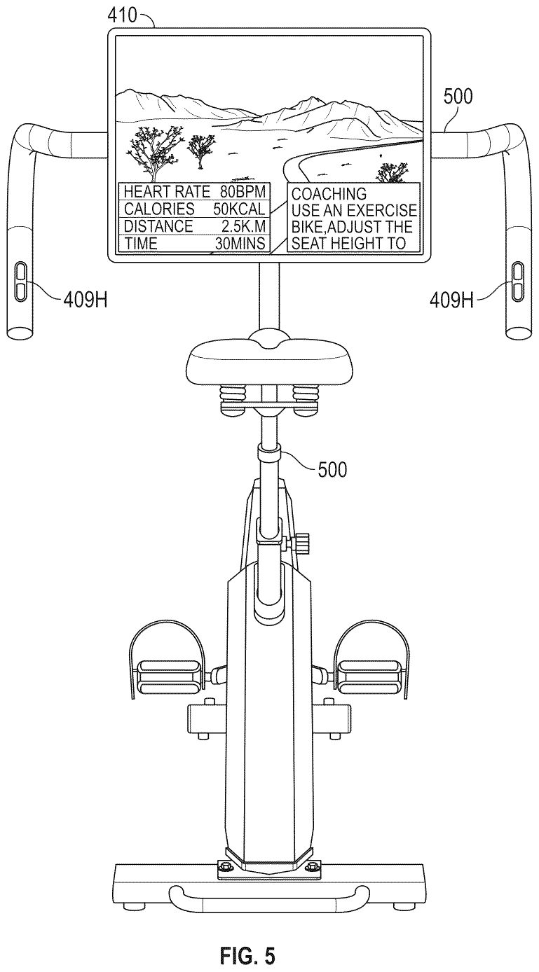

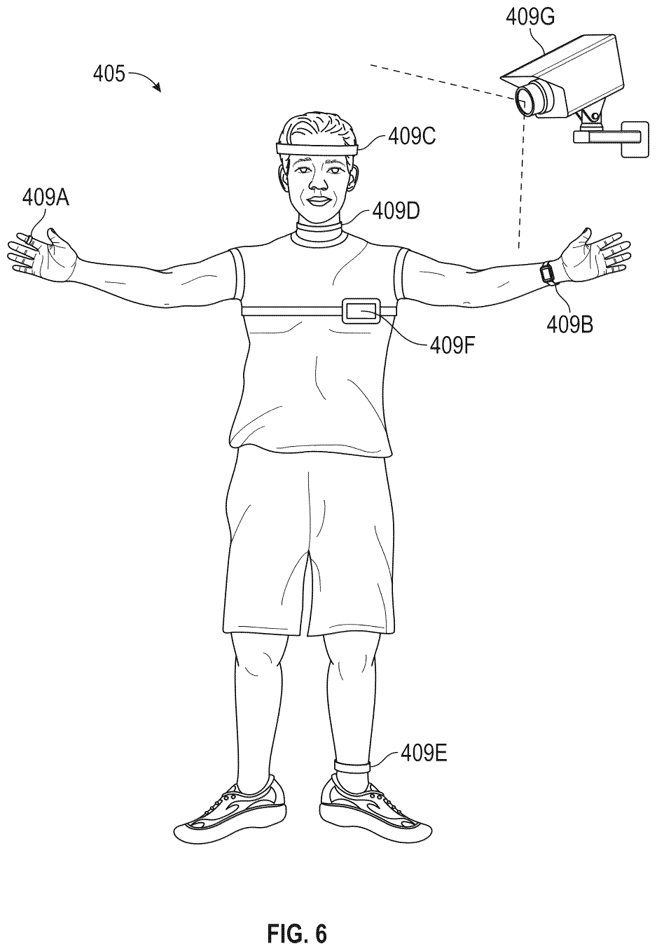

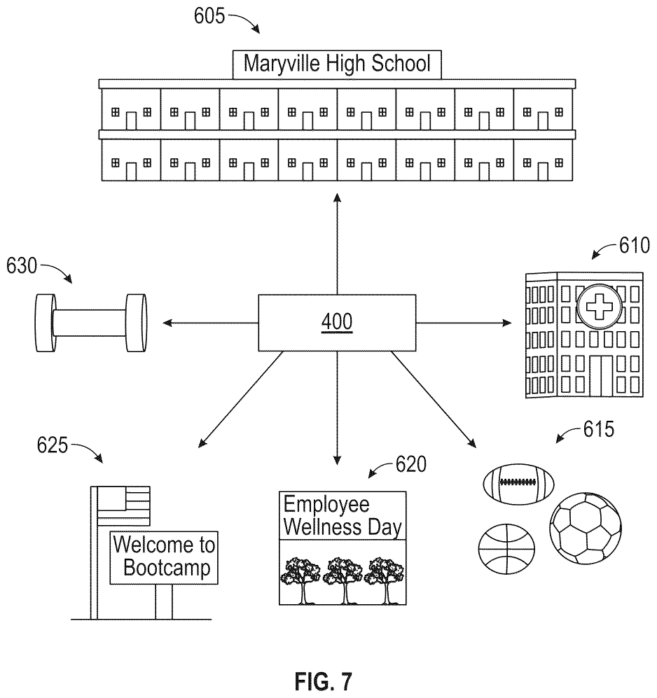

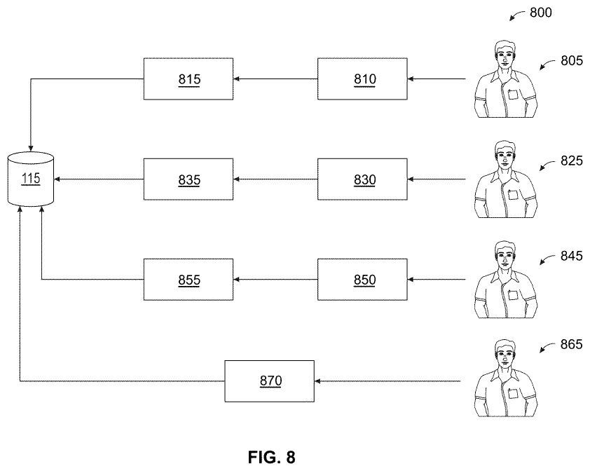

FIGS. 4-9 illustrate embodiments of a system 400 and methods for automatic coaching of a user 405 during a training session. FIG. 4 illustrates a preferred embodiment of the system 400 having a computing device 410, display 316, at least one sensor 409, and a processor 220 operably connected to said computing device, display, and at least one sensor. FIG. 5 illustrates a training device 500 having equipment-integrated sensors 409H and a user computing device 410 in the middle of a training session. FIG. 6 illustrates multiple embodiments of sensors 409 which can be used to collect biometric sensor data from a user 405. FIG. 7 illustrates various situations in which the system 400 might be effectively implemented. FIG. 8 illustrates permission levels 800 that may be utilized by the present system 400 for controlling access to user content such as user data 430A, image data 430B, application data 430C, and fitness data 430D. It is understood that the various method steps associated with the methods of the present disclosure may be carried out as operations by the system 400 shown in FIGS. 4-7.

FIG. 4 illustrates a system 400 comprising a server 110, a database 115, a processor 220, a computer-readable medium 416, and a user computing device 410 having a user interface 411 that work together to provide automatic coaching capabilities through a streaming-based architecture. In a preferred embodiment, the server 110 is configured to host at least one virtual environment and at least one machine learning technique, enabling the system 400 to execute interactive applications with sophisticated graphics and artificial intelligence processing capabilities. The user computing device 410 functions as a first computing device that includes a user interface 411 configured to manage at least one permission level of the user 405, allowing controlled access to various system features and content. In another preferred embodiment, the user interface 411 further enables control of the sensors 409 and their respective connection to the server 110. The processor 220 is operably connected to the user computing device 410, server 110, sensors 409, and display 316 to coordinate data processing and communication between these components. The computer-readable medium 416 is coupled to the processor 220 and contains instructions stored thereon that, when executed by the processor 220, cause the processor 220 to perform various operations for automatic coaching functionality. In yet another preferred embodiment, the database 115 is operably connected to the server 110 to provide centralized storage and management of application content, user profiles 430, and behavioral logic parameters.

In one preferred embodiment, the streaming architecture enables deployment to resource-constrained devices by executing interactive applications on the high-performance server 110 while transmitting rendered video and audio output to the user computing device 410 through network protocols. The user computing device 410 may require only video decode capability, basic input transmission functionality, and sensor data relay capability to participate in sophisticated interactive experiences. In a preferred embodiment, the server 110 comprises multi-core processors, discrete graphics processing units, and substantial memory capacity to handle computationally intensive operations including real-time rendering, physics calculations, and artificial intelligence processing. By contrast, the user computing device 410 may include devices with minimal processing power such as fitness equipment with ARM Cortex processors and 1-2 GB RAM, educational tablets and Chromebooks with budget specifications, medical rehabilitation equipment with embedded systems, and point-of-sale kiosks with limited hardware capabilities. The streaming approach allows the system 400 to deliver high-quality interactive experiences to devices that would otherwise be incapable of executing such applications locally. In still another preferred embodiment, the server 110 centralizes computational resources while the user computing device 410 functions as a lightweight client that displays streamed content and transmits user input data back to the server 110.

In a preferred embodiment, the database 115 stores complete application behavioral logic including activity definitions, AI personality configurations, dialogue category weights, and voice synthesis settings as database data rather than merely storing user data 430A, image data 430B, application data 430C and fitness data 430D. In another preferred embodiment, the database 115 contains structured data that defines how the virtual environment responds to user actions, how artificial intelligence characters behave and communicate, and how training activities adapt to user performance metrics. The server 110 may query the database 115 at runtime to retrieve behavioral parameters that control application mechanics such as animation speeds, difficulty scaling, performance thresholds, and response protocols. In yet another preferred embodiment, the virtual environment is generated via an artificial intelligence technique that utilizes the behavioral logic stored in the database 115 to create dynamic and responsive training scenarios. Alternatively, the virtual environment may be prebuilt with predefined elements that are modified and controlled through database-stored parameters during execution. In still another preferred embodiment, the database 115 enables instant updates to application behavior through modifications to stored logic parameters without requiring code changes or application rebuilds, allowing content creators to adjust training programs, AI personalities, and system responses in real-time.

It is recommended that the system 400 include universal HTTP service integration via database templates that enables provider-agnostic design for switching AI models, text-to-speech providers, and analytics services through database updates without code changes. For instance, the database 115 may store configuration templates for third-party API services that define request formats, authentication parameters, and response parsing instructions for various external service providers. The server 110 may utilize these templates to generate HTTP requests with variable substitution, automatic JSON and XML escaping for AI-generated text, and standardized response processing across different service providers. In such an embodiment, the computer-readable medium 416 may contain instructions that enable the processor 220 to interpret database-stored templates and construct appropriate API calls to external services based on current configuration settings. The user interface 411 would be well suited to provide administrative controls for updating service provider configurations, allowing authorized users to switch between different AI models, voice synthesis services, or analytics platforms through database modifications. The universal service integration approach eliminates vendor lock-in by abstracting service-specific implementation details into configurable database parameters, enabling the system 400 to adapt to changing service requirements or provider availability without requiring software updates or code modifications.

A user profile 430 may be associated with the user 405 and comprises a structured data organization system within the database 115 that manages multiple categories of user-specific information. In one preferred embodiment, the user profile 430 organizes and associates identifying user data 430A, image data 430B, application data 430C, and fitness data 430D of the user 405 in a hierarchical database structure that enables efficient retrieval and management of user-specific information. The user profile 430 may be associated with at least one permission level that controls access to various system features and content based on the user's role and authorization status. The database 115 may store the user profile 430 using relational database structures that maintain referential integrity between different data categories while enabling rapid queries and updates. In another preferred embodiment, the user profile 430 serves as a central repository that links all user-related information to a unique identifier, allowing the system 400 to maintain consistent user experiences across multiple sessions and devices.

The database 115 may be operably connected to the processor 220 via wired or wireless connection. In a preferred embodiment, the database 115 is configured to store user data 430A, image data 430B, application data 430C, and fitness data 430D within user profiles 430. Alternatively, the user data 430A, image data 430B, application data 430C, and fitness data 430D may be stored within user profiles 430 on the non-transitory computer-readable medium 416. The database 115 may be a relational database such that the user data 430A, image data 430B, application data 430C, and fitness data 430D associated with each user profile 430 within the plurality of user profiles 430 may be stored, at least in part, in one or more tables. Alternatively, the database 115 may be an object database such that user data 430A, image data 430B, application data 430C, and fitness data 430D associated with each user profile 430 of the plurality of user profiles 430 may be stored, at least in part, as objects. In some instances, the database 115 may comprise a relational and/or object database and a server 110 dedicated solely to managing the user data 430A, image data 430B, application data 430C, and fitness data 430D in the manners disclosed herein.

A user 405 is preferably associated with a particular user profile 430 based on a username. However, it is understood that a user 405 may be associated with a user profile 430 using a variety of methods without departing from the inventive subject matter described herein. The database 115 may be configured to store user data 430A, image data 430B, application data 430C, and fitness data 430D within user profiles 430 and/or separately. As used herein, user data 430A may be defined as information which helps to identify the user 405. In one preferred embodiment, the user data 430A within the user profile 430 comprises personal identification information, account preferences, authentication credentials, and demographic information that are stored in encrypted format within the database 115 to ensure data security and privacy protection. The user data 430A may include username, email address, age, gender, fitness goals, medical conditions, phone number, physical address, social security number, and other personal attributes that inform the system's coaching algorithms and training recommendations and enable the identification of the user 405. The database 115 may implement field-level encryption for sensitive user data 430A elements while maintaining searchable indexes for non-sensitive attributes to balance security with performance requirements. In another preferred embodiment, the user data 430A may be structured using normalized database tables that eliminate data redundancy while preserving data integrity through foreign key relationships. The server 110 may access the user data 430A through secure database queries that verify user permissions before retrieving or modifying personal information. The user interface 411 may provide controlled access to user data 430A modification functions based on the permission levels associated with the user profile 430.

As used herein, image data 430B may be defined as photographic or trace objects that represent the underlying pixel data of an area of an image element, which is created, collected, and stored using image constructor devices, such as a camera. This data may then be used by the system 400 in the various manner described herein. In a preferred embodiment, the image data 430B within the user profile 430 encompasses profile pictures, uploaded media files, progress photos, and visual content that are compressed, indexed, and stored within the database 115 using binary large object storage techniques. The image data 430B may include metadata such as upload timestamps, file sizes, image dimensions, and content descriptions that facilitate efficient retrieval and display operations. In another preferred embodiment, the database 115 implements image compression algorithms to optimize storage space while maintaining acceptable visual quality for display purposes within the user interface 411. In yet another preferred embodiment, the server 110 processes the image data 430B through automated analysis techniques to extract relevant information such as body composition changes, exercise form assessment, or progress tracking metrics. In still another preferred embodiment, the image data 430B is organized using hierarchical folder structures within the database 115 that categorize images by date, activity type, or user-defined tags. The system 400 may implement access controls for the image data 430B that respect user privacy preferences while enabling authorized sharing with trainers, medical professionals, or other designated individuals.

Application data may be defined as instructions that cause an application of the system 400 to perform an action. In one preferred embodiment, the application data 430C within the user profile 430 includes user-specific settings, configuration parameters, interface preferences, and customization options that enable personalized functionality across different system components. The application data 430C may comprise display preferences, notification settings, workout intensity preferences, AI coaching personality selections, and other user-defined parameters that influence the system's behavior and presentation. The database 115 may store the application data 430C using flexible schema structures that accommodate varying configuration requirements across different user types and system modules. In another preferred embodiment, the application data 430C includes historical interaction patterns, feature usage statistics, and behavioral analytics that inform adaptive system responses and personalized recommendations. The server 110 may utilize the application data 430C to customize the virtual environment presentation, adjust coaching communication styles, and optimize training program recommendations based on individual user preferences. The processor 220 executes instructions from the computer-readable medium 416 to dynamically apply application data 430C settings during system operation, ensuring consistent personalized experiences across multiple sessions and devices.

As used herein, fitness data 430D may be defined as information necessary to construct a virtual model of the user having at least one biometric quality. In a preferred embodiment, the fitness data 430D within the user profile 430 stores comprehensive health metrics, activity records, performance measurements, and physiological data collected from the sensors 409 during training sessions. The fitness data 430D may include heart rate measurements, exercise repetition counts, duration records, calorie expenditure calculations, strength assessments, and other quantitative metrics that track user progress over time. The database 115 may organize the fitness data 430D using time-series database structures that enable efficient storage and retrieval of chronological fitness information while supporting complex analytical queries. In another preferred embodiment, the fitness data 430D is transformed via machine learning techniques executed by the server 110 to generate fitness insights, progress assessments, and predictive recommendations for future training activities. In yet another preferred embodiment, the fitness data 430D may include baseline measurements collected during initial system setup and real-time data continuously gathered during active training sessions through the sensors 409. The system 400 may implement data validation algorithms to ensure the accuracy and consistency of fitness data 430D entries while detecting and flagging anomalous measurements that may indicate sensor malfunctions or data transmission errors.

In one preferred embodiment, the database 115 implements database-driven mechanics for instant application parameter updates through stored procedures and trigger mechanisms that enable real-time modification of core training mechanics without requiring application rebuilds or code changes. The database 115 may store animation speed parameters, timing configurations, difficulty scaling factors, and performance thresholds as structured data that the server 110 queries during application execution to control virtual environment behavior. The system 400 may utilize PostgreSQL stored procedures to implement global content propagation that can update thousands of user profiles 430 simultaneously in under two seconds through automated database triggers. In another preferred embodiment, the database 115 may contain activity definitions with timing and performance targets stored as JSON data structures that define workout intervals, intensity levels, and success criteria for various training programs. The server 110 may retrieve these database-stored parameters at runtime and apply them to control virtual environment mechanics such as animation synchronization, visual feedback triggers, and difficulty adjustments. The processor 220 may execute instructions that enable instant propagation of parameter changes across all active system instances, ensuring consistent user experiences while eliminating the traditional 2-4 hour rebuild and redistribution cycle required by conventional applications.

The system 400 may implement a multi-scope persistence architecture that maintains cross-session continuity through session memory, game instance database storage, and global system storage mechanisms that preserve user state information across multiple interaction sessions. For instance, the database 115 may store session-specific data that tracks temporary user interactions, preferences, and progress within individual training sessions while maintaining this information separately from permanent user profile 430 records. The server 110 may manage game instance storage that preserves environmental states, AI dialogue history, and activity progress in database tables that persist beyond individual session boundaries. In yet another preferred embodiment, the global system storage may maintain user achievement records, long-term progress tracking, and cross-device synchronization data that enables seamless user experiences when accessing the system 400 from different user computing devices 410. The processor 220 may execute instructions that coordinate data synchronization between these multiple persistence scopes, ensuring that user progress, preferences, and system state information remain consistent across sessions, devices, and system updates. The database 115 may implement automated backup and recovery mechanisms for all persistence scopes to prevent data loss and maintain system reliability across extended operational periods.

The processor 220 executes instructions stored on the computer-readable medium 416 to perform a series of operations that enable automatic coaching functionality through sophisticated biometric data collection and processing capabilities. In one preferred embodiment, the processor 220 receives biometric data from at least one sensor 409 that is operably connected to the user computing device 410 and configured to measure biometric data of the user 405, wherein the biometric data comprises information pertaining to the user's physical condition. The biometric data may comprise at least one of heart rate data, weight data, body temperature, and blood oxygenation that are continuously monitored during training sessions to provide real-time physiological feedback. The processor 220 simultaneously receives input data from at least one input device that is operably connected to the user computing device 410 and configured to collect input data from the user 405, wherein the input data comprises information pertaining to the physical motions of the user 405. In yet another preferred embodiment, the user interface 411 is further configured to manage the at least one input device, providing centralized control over multiple data collection sources while maintaining synchronized data streams for comprehensive user monitoring.

The processor 220 transforms the biometric data and the input data into fitness data via a machine learning technique, wherein the fitness data comprises a virtual model of the user 405 having at least one biometric attribute in the virtual environment hosted by the server 110. The machine learning technique preferably processes both baseline data collected during initial system setup and real-time data gathered continuously during active training sessions to create comprehensive user models that reflect current physiological states and performance capabilities. In a preferred embodiment, the processor 220 executes algorithms that compare the baseline data to the real-time data to identify performance trends, physiological changes, and adaptation patterns that inform training recommendations and coaching strategies. The transformation process may utilize neural networks, statistical analysis, and pattern recognition algorithms to convert raw sensor measurements into meaningful fitness metrics that accurately represent user capabilities and limitations. The virtual model generated through this transformation process includes at least one biometric attribute such as cardiovascular fitness levels, strength measurements, flexibility assessments, and endurance capabilities that are continuously updated based on incoming sensor data. The fitness data may be structured to support real-time analysis and comparison operations that enable dynamic training plan adjustments based on user performance and physiological responses.

In a preferred embodiment, the processor 220 couples the fitness data with a training plan of the user 405, wherein the training plan comprises a series of physical actions undertaken by the user 405 for the purposes of physical conditioning or physical therapy. The coupling process may involve matching user capabilities represented in the fitness data with appropriate exercise protocols, intensity levels, and progression schedules stored in the database 115 to create personalized training experiences. In another preferred embodiment, the processor 220 may execute instructions that analyze the relationship between current user fitness levels and training plan requirements to identify optimal exercise parameters, safety considerations, and performance targets. The training plan may be dynamically adjusted via the machine learning technique based on the real-time data to ensure that exercise recommendations remain appropriate for the user's current physiological state and performance capacity. The coupling operation may consider factors such as user fitness goals, medical conditions, equipment availability, and time constraints to generate comprehensive training protocols that maximize effectiveness while minimizing injury risk. The processor 220 may implement feedback loops that continuously monitor user responses to training plan elements and automatically modify exercise parameters to maintain optimal challenge levels and progression rates.

The processor 220 generates training instructions based on the fitness data via a machine learning technique, wherein the training instructions are appropriate for improving an implementation of the training plan of the user 405. The generation process may utilize a real-time application state to natural language translation layer that automatically converts technical metrics to contextual descriptions for AI prompt generation, enabling the system 400 to communicate complex physiological data in user-friendly language. The processor 220 may implement template-guided AI generation that combines template-based and generative AI approaches to produce infinite dialogue variety while maintaining character personality consistency throughout coaching interactions. The training instruction generation may incorporate environmental factors, user preferences, and historical performance data to create contextually relevant guidance that adapts to changing workout conditions and user needs. The machine learning technique may analyze patterns in user responses to different instruction types and automatically optimize communication styles, complexity levels, and motivational approaches based on individual user preferences and effectiveness metrics. The processor 220 may execute algorithms that ensure training instructions remain technically accurate while being presented in accessible language that encourages user engagement and compliance with training protocols.

In one preferred embodiment, the processor 220 implements a cross-system context injection architecture that links environmental state systems, performance tracking systems, and AI dialogue systems via shared context to create seamless integration between different system components. The context injection architecture may extract real-time information from multiple system modules including virtual environment conditions, user performance metrics, sensor readings, and training plan progress to create comprehensive situational awareness for AI coaching systems. The processor 220 may execute instructions that automatically translate technical measurements such as heart rate zones, exercise cadence, and power output into natural language descriptions that can be incorporated into AI-generated coaching dialogue. The environmental state systems may provide information about virtual world conditions, lighting, weather simulation, and background elements that influence the context and tone of coaching communications delivered to the user 405. The performance tracking systems may supply real-time metrics about user exercise form, intensity levels, completion rates, and physiological responses that inform adaptive coaching strategies and safety monitoring protocols. The AI dialogue systems may utilize the aggregated context information to generate personalized, situationally appropriate coaching instructions that respond to immediate user needs while maintaining consistency with long-term training objectives.

In a preferred embodiment, the processor 220 presents the training instructions to the user 405 via a display 316 that is operably connected to the user computing device 410 and configured to display image data of the virtual world to the user 405. The presentation process may involve rendering visual coaching cues, textual instructions, graphical performance feedback, and interactive elements within the virtual environment to create immersive training experiences that engage multiple sensory channels. The display 316 may present real-time biometric data visualizations, progress indicators, and performance comparisons that enable users to monitor their physiological responses and training effectiveness during exercise sessions. The processor 220 may execute instructions that synchronize the presentation of training instructions with user actions, environmental changes, and physiological responses to maintain optimal timing and relevance of coaching communications. The virtual world image data may include animated coaching avatars, environmental feedback elements, and interactive objects that respond to user performance and provide visual reinforcement of training instructions and motivational messages. The display presentation may be customized based on user preferences, device capabilities, and environmental conditions to ensure optimal visibility and comprehension of training instructions across different usage scenarios. In a preferred embodiment, the processor 220 implements adaptive display algorithms that automatically adjust instruction presentation formats, timing, and complexity based on user attention patterns, comprehension rates, and performance responses to optimize coaching effectiveness and user engagement.

A fitness device may be defined as a device configured to facilitate or measure physical activity of a user. Fitness devices that may be operably connected to the computing device and/or display include, but are not limited to, heart rate monitors, accelerometers, global positioning systems (GPS), galvanic skin response sensors, thermometers, ambient light sensors, UV sensors, or any combination thereof. Fitness devices may also be connected to training equipment 500 designed to facilitate one or more types of exercise, such as a leg press. Such devices may record repetitions, time between sets, resistance, and other data as fitness data 430D associated with the user profile 430, which may then be used as training data for AI analytics. In one preferred embodiment, fitness devices are moveably attached to a display 316, allowing a user to remove the fitness device and attach it to their person so that said fitness device may collect fitness data for the system. For instance, a heart rate monitor may be removably secured to the display in a way such that a user 405 may remove said heart rate monitor from a mount of said display so that hear rate data may be collected and saved in the form of fitness data 430B. In another preferred embodiment, fitness devices may be configured to operably connect to the display and not be physically secured to the display in any way. For instance, a user's smart watch-having an accelerometer and gyroscope configured to collect fitness data 430D in the form of linear acceleration data and angular acceleration data, respectively-may be used by the system to collect fitness data during a fitness session, wherein the fitness data is presented in one or more display windows of the display user interface along with image data of a fitness instructional video.

FIG. 5 illustrates training equipment 500 comprising a stationary exercise bicycle configuration that provides a stable platform for integrating digital coaching capabilities with physical exercise activities. The training equipment 500 may include a base frame structure that supports pedals, an adjustable seat mounted on a vertical support post, and handlebars that extend from either side of a centrally mounted user computing device 410. In one preferred embodiment, the training equipment 500 may be configured as various types of cardiovascular exercise equipment including treadmills, rowing machines, elliptical trainers, and stationary bicycles that accommodate different exercise modalities and user preferences. The physical configuration of the training equipment 500 may incorporate adjustable components such as seat height mechanisms, handlebar positioning systems, and resistance control interfaces that enable customization for different user body types and fitness levels. In another preferred embodiment, the training equipment 500 may include physical therapy equipment such as rehabilitation bikes, upper body ergometers, and balance training platforms that support medical recovery and therapeutic exercise protocols. The structural design of the training equipment 500 may prioritize stability and safety through reinforced frame construction, non-slip surfaces, and emergency stop mechanisms that ensure user protection during exercise activities.

In a preferred embodiment, the user computing device 410 integrates with the training equipment 500 through a secure mounting system that positions the device at an optimal viewing angle for displaying workout information and coaching instructions during exercise sessions. In one preferred embodiment, the user computing device 410 may be positioned at the front of the training equipment 500 to provide easy access to display content while maintaining proper exercise posture and form. The display screen of the user computing device 410 may present real-time workout metrics including heart rate measurements, calorie expenditure calculations, distance tracking, and elapsed time information that enable users to monitor their exercise progress and performance. The user computing device 410 simultaneously display coaching instructions generated by the server 110 through the streaming architecture, providing personalized guidance and motivational content that adapts to user performance and physiological responses. In another preferred embodiment, the user computing device 410 may present graphical representations of virtual training environments including landscape scenes, interactive coaching avatars, and visual feedback elements that enhance user engagement and exercise motivation. The integration design may ensure that the user computing device 410 remains securely attached to the training equipment 500 during vigorous exercise activities while maintaining clear visibility and accessibility for user interaction.

Equipment-integrated sensors 409H are positioned about the training equipment 500 and configured to collect biometric data from the user 405 through direct physical contact during exercise activities. In one preferred embodiment, the equipment-integrated sensors 409H may be located symmetrically on both the left and right handlebar grips to ensure consistent data collection regardless of user hand positioning and grip preferences. The equipment-integrated sensors 409H may utilize capacitive sensing technology, optical measurement techniques, or bioelectrical impedance analysis to capture heart rate data, skin conductance measurements, and other physiological parameters through palm and finger contact with the sensor surfaces. The positioning of the equipment-integrated sensors 409H on the handlebars may provide continuous biometric monitoring without requiring additional wearable devices or external sensor attachments that might interfere with natural exercise movements. In another preferred embodiment, the equipment-integrated sensors 409H may incorporate multiple sensing modalities within a single sensor unit to collect diverse biometric measurements including pulse rate, blood oxygen saturation, and skin temperature through integrated sensor arrays. The equipment-integrated sensors 409H may transmit collected biometric data to the user computing device 410 through wired or wireless communication protocols that ensure reliable data transmission during exercise activities.

The system 400 maintains a clear distinction between biometric sensors that collect physiological data and input devices that capture non-biometric input data for constructing virtual models of the user 405 within the virtual environment. In one preferred embodiment, biometric sensors including the equipment-integrated sensors 409H, heart rate monitors, and blood oxygen sensors may focus specifically on measuring physiological parameters such as cardiovascular responses, metabolic indicators, and autonomic nervous system activity that reflect the user's physical condition and exercise intensity. Input devices may include motion sensors, position encoders, force transducers, and user interface controls that capture information about physical movements, exercise form, equipment settings, and user interactions with the training equipment 500. The input data collected from these devices may comprise information pertaining to the physical motions of the user 405 including pedaling cadence, resistance levels, range of motion measurements, and exercise technique parameters that enable accurate virtual representation of user activities. In another preferred embodiment, the processor 220 may process both biometric data and input data through separate analytical pathways that preserve the distinct characteristics of physiological measurements versus mechanical performance metrics. The machine learning techniques implemented by the server 110 may utilize both data types to create comprehensive virtual models that accurately represent both the user's physical capabilities and their real-time physiological responses to exercise stimuli. The integration of biometric sensors and input devices may provide complementary data streams that enable holistic assessment of user performance, safety monitoring, and adaptive training plan modifications.

The streaming architecture enables deployment of sophisticated interactive applications to the resource-constrained user computing device 410 integrated with the training equipment 500 by executing computationally intensive operations on the high-performance server 110 while transmitting rendered output to the device. In one preferred embodiment, the user computing device 410 may have minimal processing capabilities including basic ARM processors, limited memory capacity, and simple video decode functionality that would normally prevent execution of graphics-intensive fitness applications with advanced AI coaching features. The server 110 may execute complex virtual environment rendering, real-time physics calculations, machine learning algorithms, and AI dialogue generation that require substantial computational resources including multi-core processors, discrete graphics cards, and extensive memory capacity. The streaming architecture may transmit compressed video and audio streams from the server 110 to the user computing device 410 through network protocols that optimize bandwidth usage while maintaining responsive user experiences during exercise activities. In another preferred embodiment, the user computing device 410 may function as a lightweight client that displays streamed content, transmits user input data, and relays sensor information to the server 110 without requiring local storage of application code or content assets. The streaming approach may enable the training equipment 500 to offer premium interactive experiences comparable to high-end gaming systems while utilizing cost-effective embedded computing devices that reduce equipment manufacturing costs and maintenance requirements.

The system 400 may integrate external devices including heart rate monitors, smart watches, fitness equipment sensors, cadence sensors, power meters, and GPS watches through database-stored thresholds and response protocols without requiring device-specific code modifications or custom integration development. In one preferred embodiment, the database 115 may store universal device integration templates that define communication protocols, data parsing instructions, and response thresholds for various external sensor types that can report data to the system 400 through standardized interfaces. The server 110 may utilize these database-stored templates to automatically configure communication with new external devices by matching device capabilities with appropriate integration protocols stored in the database 115. External devices may transmit biometric data, performance metrics, and environmental measurements to the user computing device 410 or directly to the server 110 through wireless communication protocols including Bluetooth, WiFi, and cellular data connections. In another preferred embodiment, the database 115 may contain configurable threshold parameters for different external device types that enable automatic response generation based on sensor readings without requiring hardcoded device-specific logic in the application code. The processor 220 may execute instructions that interpret external device data according to database-stored protocols and generate appropriate coaching responses, safety alerts, or training plan adjustments based on the received measurements and predefined threshold criteria. The universal external device integration approach may enable the system 400 to support emerging sensor technologies and new device types through database configuration updates rather than software development cycles.

In some preferred embodiments, the system 400 may further comprise a secondary security device. Devices that may act as the secondary security device may include, but are not limited to, biometric devices, key cards, wearables, or any combination thereof. In a preferred embodiment, devices that may act as biometric devices include, but are not limited to, contact biometric devices, such as fingerprint scanners and hand geometry scanners, and/or non-contact biometric devices, such as face scanners, iris scanners, retina scanners, palm vein scanners, and voice identification devices. In some embodiments, the secondary security device may be operably connected to the computing device 410 and/or display 316 in a way such that it is in direct communication with the computing device 410 and/or display 316 and no other computing device 410 and/or display 316. In some preferred embodiments, biometric data associated with a user is saved in a user profile as user data, which the system uses to verify a user's identity. For instance, secondary security devices may be securely and directly connected to a first computing device and a second computing device in a way such that both a first user of the first computing device and a second user of the second computing device must biometrically scan thumbprints prior to the system allowing the first user and second user to access data of the system.

In a preferred embodiment, key cards and wearables preferably comprise a secure transmitter configured to transmit a login credentials to the computing device. Wearables having a secure transmitter include clothing and accessories, such as shirts, pants, jackets, belts, shoes, wristbands, watches, glasses, pins, nametags, etc., that have said transmitter attached thereto and/or incorporated therein. The secure transmitter preferably contains login credentials in the form of a unique ID, which may be conveyed to a computing device in the form of a computer readable signal. Unique IDs contained within the computer readable signal that has been broadcast by the transmitter may include, but are not limited to, unique identifier codes, social security numbers, personal identification numbers (PINs), etc. For instance, a computer readable signal broadcast by a secondary security device in the form of a wrist band may contain information that will alert the computing device that a particular user 405 is within a certain range, which may cause the system 400 to allow a user to access data of the system if additional steps are taken.

Types of devices that may act as the transmitter include, but are not limited, to near field communication (NFC), Bluetooth, infrared (IR), radio-frequency communication (RFC), radio-frequency identification (RFID), and ANT+, or any combination thereof. In an embodiment, transmitters may broadcast signals of more than one type. For instance, a transmitter comprising an IR transmitter and RFID transmitter may broadcast IR signals and RFID signals. Alternatively, a transmitter may broadcast signals of only one type of signal. For instance, identification (ID) cards may be fitted with transmitters that broadcast NFC signals containing unique IDs associated with a particular user, wherein displays equipped with NFC receivers must receive said NFC signals containing unique IDs before access to one or more features of the display user interface may be granted.

Use of secondary security devices may be used solely or in addition to secondary security methods of the system, allowing the system to have flexible multifactor identification. Simultaneous use may be beneficial to prevent unauthorized access to data of the system and/or communications between users of the system, including personal trainers and/or healthcare professionals. For instance, a user may use both a secondary security method and biometric scanner for identification purposes before allowing a user to access the various features of the system. In another preferred embodiment, the system may use a secondary security method for identification purposes and a wearable for activating other features of the system, such as access to paid fitness classes, personal trainers, and/or healthcare professionals. For instance, a user may use a secondary security method to allow the system to identify a user and associate a computing device of the user with a display. The secure transmitter of a wearable in the form of a smartwatch may transmit a computer readable signal to the display in a way such that it will allow a user to access additional features of the system that allow access to fitness instructors and dieticians. Fitness devices of the user may transmit fitness data to the display where it may be presented to fitness instructors during a fitness instructional video.

FIG. 6 illustrates a comprehensive distributed sensor configuration that enables the system 400 to collect diverse physiological and performance data from multiple body locations simultaneously through strategically positioned biometric sensors 409 worn by the user 405. In one preferred embodiment, a finger sensor 409A is positioned on the hand of the user 405 to monitor pulse rate, blood oxygen levels, and skin conductance measurements through fingertip contact with advanced photoplethysmography technology. The finger sensor 409A may utilize optical sensing techniques that detect blood volume changes in the fingertip capillaries to calculate heart rate variability and cardiovascular response patterns during exercise activities. In another preferred embodiment, the finger sensor 409A on the hand is positioned to provide continuous biometric monitoring without interfering with natural hand movements or grip positions during training equipment 500 operation. In yet another preferred embodiment, the finger sensor 409A may incorporate multiple sensing modalities within a compact form factor that enables simultaneous collection of cardiovascular, respiratory, and autonomic nervous system measurements. The finger sensor 409A may transmit collected biometric data to the user computing device 410 through wireless communication protocols that ensure reliable data transmission during dynamic exercise movements.

In one preferred embodiment, a wrist sensor 409B may be positioned on the wrist of the user 405 to provide comprehensive tracking of heart rate, movement patterns, acceleration data, and other wrist-based physiological measurements through integrated sensor arrays. The wrist sensor 409B may utilize bioelectrical impedance analysis, optical heart rate monitoring, and inertial measurement units to capture diverse biometric parameters including cardiovascular responses, physical activity levels, and motion characteristics. The wrist-mounted configuration of the wrist sensor 409B preferably enables continuous monitoring throughout extended training sessions while maintaining user comfort and freedom of movement during various exercise modalities. In another preferred embodiment, the wrist sensor 409B may incorporate GPS tracking capabilities, ambient light sensors, and skin temperature monitoring to provide environmental context and additional physiological measurements that inform training plan adaptations. The wrist sensor 409B may implement advanced signal processing algorithms to filter motion artifacts and maintain measurement accuracy during vigorous physical activities. The positioning of the wrist sensor 409B may optimize sensor contact with the radial artery and surrounding tissue to ensure consistent and reliable biometric data collection across different user wrist sizes and anatomical variations.

A head sensor 409C may be mounted on the head of the user 405 to collect data related to head movement, orientation, balance, and neurological activity patterns that provide insights into exercise form, coordination, and cognitive engagement during training activities. The head sensor 409C may utilize accelerometers, gyroscopes, and magnetometers to track head position changes, rotational movements, and spatial orientation that indicate proper exercise technique and postural alignment. The head-mounted configuration of the head sensor 409C may enable monitoring of vestibular function, balance responses, and head stability that are particularly valuable for rehabilitation applications and balance training protocols. In another preferred embodiment, the head sensor 409C may incorporate electroencephalography sensors or near-infrared spectroscopy technology to monitor brain activity, cognitive load, and mental engagement levels during training sessions. The head sensor 409C may provide real-time feedback about user attention, focus, and mental fatigue that enables adaptive coaching strategies and optimal training intensity management. The positioning of the head sensor 409C may be designed to minimize interference with natural head movements while maintaining secure attachment during dynamic exercise activities that involve rapid directional changes or impact forces.

In one preferred embodiment, a neck sensor 409D may be positioned around the neck area of the user 405 to monitor physiological parameters accessible from the cervical region including carotid pulse measurements, respiratory patterns, and vocal cord activity during exercise sessions. The neck sensor 409D may utilize pressure sensors, acoustic monitoring, and optical measurement techniques to capture cardiovascular responses, breathing rates, and vocalization patterns that indicate exercise intensity and user communication needs. The neck-mounted configuration of the neck sensor 409D may provide access to major blood vessels and respiratory pathways that offer reliable physiological measurements complementary to other sensor locations. In another preferred embodiment, the neck sensor 409D may incorporate sweat analysis capabilities, skin conductance monitoring, and temperature sensing to assess hydration status, stress responses, and thermoregulatory function during training activities. The neck sensor 409D may implement voice recognition algorithms to detect user verbal responses, coaching acknowledgments, and safety communications that inform AI dialogue systems and emergency response protocols. The positioning of the neck sensor 409D may be optimized to maintain comfortable contact with the neck region while avoiding interference with natural head movements, breathing patterns, or exercise equipment interactions.

In a preferred embodiment, an ankle sensor 409E may be attached to the lower leg near the ankle of the user 405 to facilitate tracking of lower body movement, cadence, stride patterns, and other leg-based performance metrics that are particularly valuable for cardiovascular exercise and gait analysis applications. The ankle sensor 409E may utilize inertial measurement units, pressure sensors, and magnetic field detectors to capture step count, stride length, ground contact time, and foot strike patterns during walking, running, or cycling activities. The ankle-mounted configuration of the ankle sensor 409E may provide detailed biomechanical data about lower extremity function, joint mobility, and movement efficiency that inform exercise technique optimization and injury prevention strategies. In another preferred embodiment, the ankle sensor 409E may incorporate force sensors, impact detection algorithms, and range of motion monitoring to assess joint stability, muscle activation patterns, and movement quality during various exercise modalities. The ankle sensor 409E may transmit real-time movement data to the processor 220 for analysis of exercise form, performance consistency, and progression tracking across multiple training sessions. The positioning of the ankle sensor 409E may be designed to capture comprehensive lower body movement data while maintaining secure attachment during high-impact activities and rapid directional changes.

A chest sensor 409F may be positioned on the chest area of the user 405 to provide access to heart rate monitoring, breathing patterns, respiratory rate measurements, and other thoracic physiological parameters through direct contact with the chest wall and surrounding tissue. The chest sensor 409F may utilize electrocardiography electrodes, strain gauge sensors, and impedance measurement techniques to capture detailed cardiovascular and respiratory data including heart rhythm variability, breathing depth, and chest expansion patterns. The chest-mounted configuration of the chest sensor 409F may offer the most accurate heart rate monitoring capabilities due to proximity to the heart and reduced motion artifacts compared to peripheral sensor locations. In another preferred embodiment, the chest sensor 409F may incorporate multiple sensing elements arranged in an array configuration to monitor cardiac electrical activity, respiratory mechanics, and chest wall movement patterns that provide comprehensive cardiopulmonary assessment during exercise activities. The chest sensor 409F may implement advanced signal processing algorithms to distinguish between cardiac signals, respiratory movements, and exercise-induced motion artifacts to maintain measurement accuracy during dynamic training sessions. The positioning of the chest sensor 409F may be optimized to maintain consistent contact with the chest wall while accommodating different body types, clothing configurations, and exercise movement patterns.

A camera 409G may be positioned external to the user 405 and mounted on a support structure oriented toward the user 405 to enable visual monitoring and analysis of the user's movements, posture, exercise form, and physical characteristics during training activities through non-contact sensing capabilities. The camera 409G may utilize computer vision algorithms, motion tracking technology, and image analysis techniques to assess exercise technique, body alignment, range of motion, and movement quality without requiring physical contact or wearable device attachment. The external positioning of the camera 409G may provide comprehensive visual coverage of the user's entire body and exercise area while maintaining optimal viewing angles for accurate movement analysis and form assessment. In another preferred embodiment, the camera 409G may incorporate infrared imaging, depth sensing, and facial recognition capabilities to monitor physiological indicators such as skin temperature, breathing patterns, facial expressions, and stress responses through advanced optical measurement techniques. The camera 409G may implement real-time image processing algorithms that extract quantitative movement data, posture measurements, and exercise performance metrics that complement the data collected from wearable sensors 409. The non-contact sensing approach of the camera 409G may provide valuable backup monitoring capabilities and enable assessment of users who cannot or prefer not to wear multiple biometric sensors during training sessions.

The distributed sensor arrangement enables the system 400 to implement universal device integration that connects various wearables and sensors through database-stored thresholds and response protocols without requiring device-specific code modifications or custom integration development for each sensor type. In one preferred embodiment, the database 115 may store universal integration templates that define communication protocols, data parsing instructions, and threshold parameters for different sensor categories including heart rate monitors, accelerometers, GPS devices, and environmental sensors that can report data through standardized interfaces. The server 110 may utilize these database-stored templates to automatically configure communication with new sensor devices by matching device capabilities with appropriate integration protocols stored in the database 115 without requiring software updates or code changes. The sensors 409 may transmit collected biometric data to the user computing device 410 through wireless communication protocols including Bluetooth, WiFi, and cellular data connections that ensure reliable data transmission during exercise activities. In another preferred embodiment, the database 115 may contain configurable threshold parameters for different sensor types that enable automatic response generation based on sensor readings including heart rate zones, activity intensity levels, and safety alert criteria. The processor 220 may execute instructions that interpret sensor data according to database-stored protocols and generate appropriate coaching responses, training plan adjustments, or safety notifications based on the received measurements and predefined threshold criteria.

The system 400 may implement a multi-tier weighted probabilistic selection system that utilizes the comprehensive biometric data collected from the distributed sensor configuration to inform content selection algorithms and personalized coaching response generation. In one preferred embodiment, the weighted content selection system may utilize primary weights for sentence length selection that determine the complexity and duration of coaching instructions based on current user physiological state, exercise intensity, and cognitive load as measured by the sensors 409. The system 400 may implement secondary weights for category selection that prioritize different types of coaching content including motivational messages, technical instruction, safety guidance, and performance feedback based on real-time biometric data patterns and user response history. The processor 220 may execute context filtering algorithms that exclude inappropriate content categories based on current physiological state measurements such as elevated heart rate, high stress indicators, or fatigue markers detected by the sensors 409. In another preferred embodiment, the weighted selection system may implement template filtering mechanisms that exclude previously used coaching templates from the selection pool based on session memory and global history tracking to prevent repetitive interactions. The multi-tier approach may enable fine-grained control over coaching content delivery that adapts to immediate physiological needs while maintaining variety and engagement throughout extended training sessions. The biometric data from the sensors 409 may continuously inform the weighting algorithms to ensure that coaching content remains appropriate for the user's current physical condition and exercise performance level.

FIG. 7 illustrates various environments across which the system 400 may be deployed, demonstrating the versatility and adaptability of the streaming-based architecture for delivering sophisticated interactive applications to diverse user populations and use cases. In one preferred embodiment, an educational setting 605 comprises schools, universities, training centers, and other learning institutions where the system 400 provides interactive educational content including virtual laboratory experiences, simulation-based learning modules, and AI-tutored instruction programs that can be deployed to budget computing devices such as Chromebooks and basic tablets. The centralized fleet management capabilities enable educational administrators to instantly update curriculum content across hundreds or thousands of devices simultaneously, ensuring consistent educational experiences while reducing IT maintenance overhead and eliminating the need for individual device updates. The rapid content update functionality allows educators to modify lesson plans, assessment criteria, and instructional materials in real-time based on student performance data and curriculum changes, while the database-driven architecture enables personalized learning paths that adapt to individual student capabilities and progress rates. The streaming approach enables deployment of graphically intensive educational simulations and virtual reality experiences to resource-constrained educational devices that would otherwise be incapable of executing such sophisticated applications locally. The system 400 may support integration with educational management systems and student information databases to provide comprehensive tracking of learning outcomes and performance analytics across entire educational networks. The universal device integration capabilities enable connection of various educational sensors and input devices including interactive whiteboards, student response systems, and biometric monitoring equipment through database-stored protocols without requiring custom software development for each device type.

A medical setting 610 may encompass hospitals, rehabilitation centers, physical therapy clinics, and other healthcare facilities where the system 400 delivers therapeutic applications including rehabilitation programs, physical therapy protocols, and medical training simulations that support patient recovery and healthcare professional education. The centralized management architecture enables healthcare administrators to deploy standardized treatment protocols across multiple facilities while maintaining compliance with medical regulations and ensuring consistent patient care quality through synchronized content delivery. The rapid content update capabilities allow medical professionals to modify rehabilitation programs, adjust therapy parameters, and update treatment protocols based on patient progress data and evolving medical best practices without requiring on-site technical support or device-specific updates. The streaming-based deployment enables sophisticated medical simulations and interactive therapy applications to run on basic embedded systems integrated into medical equipment, reducing hardware costs while providing advanced therapeutic capabilities. The system 400 may integrate with electronic health records and medical monitoring systems to provide comprehensive patient tracking and outcome measurement across extended treatment periods. The database-driven approach enables personalized therapy programs that adapt to individual patient capabilities, medical conditions, and recovery progress while maintaining detailed records for medical documentation and insurance reporting requirements. The universal sensor integration capabilities support connection of various medical monitoring devices including heart rate monitors, blood pressure sensors, and motion tracking equipment through standardized database protocols.

A professional athletic setting 615 may include sports training facilities, athletic performance centers, professional team facilities, and competitive sports venues where the system 400 provides advanced training programs, performance analysis tools, and AI-coached skill development applications for elite athletes and sports professionals. The centralized fleet management enables sports organizations to deploy consistent training protocols across multiple facilities, training camps, and competition venues while maintaining synchronized performance tracking and analytics across entire athletic programs. The rapid content update functionality allows coaches and sports scientists to modify training regimens, adjust performance targets, and update skill development programs based on real-time athlete performance data and competitive analysis without requiring individual device updates or software installations. The streaming architecture enables deployment of sophisticated biomechanical analysis applications and virtual reality training environments to basic computing devices integrated into training equipment, providing professional-grade performance analysis capabilities at reduced hardware costs. The system 400 may integrate with sports performance monitoring systems and athlete management databases to provide comprehensive tracking of training loads, performance metrics, and injury prevention protocols across extended training periods. The database-driven approach enables personalized training programs that adapt to individual athlete capabilities, sport-specific requirements, and performance goals while maintaining detailed records for performance analysis and competitive strategy development. The universal device integration capabilities support connection of various sports monitoring equipment including power meters, GPS tracking devices, and biomechanical sensors through database-stored protocols without requiring sport-specific software development.

A corporate wellness setting 620 may comprise workplace fitness centers, employee wellness programs, corporate health initiatives, and occupational health facilities where the system 400 delivers workplace fitness applications, stress management programs, and employee health monitoring solutions that support organizational wellness objectives and employee health outcomes. The centralized management architecture enables human resources departments and wellness coordinators to deploy standardized wellness programs across multiple office locations, remote work sites, and corporate facilities while maintaining consistent employee engagement and health tracking capabilities. The rapid content update functionality allows wellness administrators to modify fitness programs, adjust health challenges, and update wellness content based on employee participation data and organizational health goals without requiring individual device management or software updates. The streaming-based deployment enables sophisticated fitness applications and stress management tools to run on basic computing devices in workplace environments, providing professional wellness capabilities without requiring expensive fitness equipment or specialized hardware installations. The system 400 may integrate with employee health records and corporate wellness platforms to provide comprehensive tracking of employee fitness levels, wellness program participation, and health outcome metrics across entire organizations. The database-driven approach enables personalized wellness programs that adapt to individual employee health status, fitness goals, and work schedules while maintaining privacy protection and compliance with occupational health regulations. The universal sensor integration capabilities support connection of various workplace health monitoring devices including desk-based fitness equipment, environmental sensors, and wearable devices through standardized database protocols.

A military setting 625 may encompass military training facilities, defense installations, combat readiness centers, and military medical facilities where the system 400 provides tactical training simulations, physical fitness programs, and combat readiness applications that support military personnel training and operational preparedness. The centralized fleet management enables military commanders and training coordinators to deploy standardized training protocols across multiple bases, deployment locations, and training facilities while maintaining synchronized performance tracking and readiness assessment capabilities. The rapid content update functionality allows military trainers to modify training scenarios, adjust fitness standards, and update tactical procedures based on operational requirements and mission-specific needs without requiring individual device updates or specialized technical support. The streaming architecture enables deployment of sophisticated combat simulations and tactical training environments to ruggedized computing devices and field equipment, providing advanced training capabilities in challenging operational environments. The system 400 may integrate with military personnel databases and readiness tracking systems to provide comprehensive monitoring of soldier fitness levels, training completion rates, and operational readiness metrics across military units and deployment cycles. The database-driven approach enables personalized training programs that adapt to individual soldier capabilities, military occupational specialties, and deployment requirements while maintaining detailed records for personnel evaluation and career development purposes. The universal device integration capabilities support connection of various military monitoring equipment including tactical sensors, environmental monitoring devices, and specialized military hardware through database-stored protocols without requiring custom military software development.

A personal fitness setting 630 may include home fitness environments, personal training studios, residential wellness spaces, and individual fitness equipment installations where the system 400 provides personalized workout programs, AI coaching services, and home fitness solutions that support individual health and fitness goals. The centralized management architecture enables fitness service providers and personal trainers to deliver consistent training experiences across multiple client locations while maintaining synchronized progress tracking and program customization capabilities. The rapid content update functionality allows personal trainers and fitness professionals to modify workout programs, adjust training intensity, and update fitness content based on individual client progress and changing fitness goals without requiring in-person visits or manual equipment updates. The streaming-based deployment enables sophisticated fitness applications and virtual personal training to run on basic home computing devices and consumer fitness equipment, providing professional-grade fitness coaching without requiring expensive specialized equipment or high-end computing hardware. The system 400 may integrate with personal health tracking applications and consumer fitness devices to provide comprehensive monitoring of individual fitness progress, health metrics, and wellness outcomes across extended training periods. The database-driven approach enables highly personalized fitness programs that adapt to individual health status, fitness experience, and personal preferences while maintaining detailed progress records for long-term health tracking and goal achievement. The universal sensor integration capabilities support connection of various consumer fitness devices including smart watches, heart rate monitors, and home fitness equipment through standardized database protocols without requiring device-specific application development.

The system 400 preferably uses machine learning techniques to perform the methods disclosed herein, wherein the instructions carried out by the processor 220 for said machine learning techniques are stored on the non-transitory computer-readable medium 416, server 110, and/or database 115. Machine learning techniques that may be used by the system 400 include, but are not limited to, classification algorithms, neural network algorithm, regression algorithms, decision tree algorithms, clustering algorithms, genetic algorithms, supervised learning algorithms, semi-supervised learning algorithms, unsupervised learning algorithms, deep learning algorithms, or other types of algorithms. More specifically, machine learning algorithms can include implementations of one or more of the following algorithms: support vector machine, decision tree, nearest neighbor algorithm, random forest, ridge regression, Lasso algorithm, k-means clustering algorithm, boosting algorithm, spectral clustering algorithm, mean shift clustering algorithm, non-negative matrix factorization algorithm, elastic net algorithm, Bayesian classifier algorithm, RANSAC algorithm, orthogonal matching pursuit algorithm, bootstrap aggregating, temporal difference learning, backpropagation, online machine learning, Q-learning, stochastic gradient descent, least squares regression, logistic regression, ordinary least squares regression (OLSR), linear regression, stepwise regression, multivariate adaptive regression splines (MARS), locally estimated scatterplot smoothing (LOESS) ensemble methods, clustering algorithms, centroid based algorithms, principal component analysis (PCA), singular value decomposition, independent component analysis, k nearest neighbors (kNN), learning vector quantization (LVQ), self-organizing map (SOM), locally weighted learning (LWL), apriori algorithms, eclat algorithms, regularization algorithms, ridge regression, least absolute shrinkage and selection operator (LASSO), elastic net, classification and regression tree (CART), iterative dichotomiser 3 (ID3), C4.5 and C5.0, chi-squared automatic interaction detection (CHAID), decision stump, M5, conditional decision trees, least-angle regression (LARS), naive bayes, gaussian naïve bayes, multinomial naïve bayes, averaged one-dependence estimators (AODE), bayesian belief network (BBN), bayesian network (BN), k-medians, expectation maximisation (EM), hierarchical clustering, perceptron back-propagation, hopfield network, radial basis function network (RBFN), deep boltzmann machine (DBM), deep belief networks (DBN), convolutional neural network (CNN), stacked auto-encoders, principal component regression (PCR), partial least squares regression (PLSR), sammon mapping, multidimensional scaling (MDS), projection pursuit, linear discriminant analysis (LDA), mixture discriminant analysis (MDA), quadratic discriminant analysis (QDA), flexible discriminant analysis (FDA), bootstrapped aggregation (bagging), adaboost, stacked generalization (blending), gradient boosting machines (GBM), gradient boosted regression trees (GBRT), random forest, or even algorithms yet to be invented.

In a preferred embodiment, the machine learning techniques comprise instructions configured to create a trained machine learning techniques from at least some training data and according to an implementation of the machine learning techniques, wherein the training data serves as a baseline dataset that may act as the foundational data of the machine learning techniques. The instructions of the machine learning techniques dictate how the machine learning techniques gain knowledge from the various data sources of the system and may comprise various types of programable instructions that include, but are not limited to, local commands, remote commands, executable files, protocol commands, selected commands, or any combination thereof. The instructions of the machine learning techniques may vary widely, depending on a desired implementation. In a preferred embodiment, instructions may include streamed-lined instructions that instruct the machine learning techniques on how to train the system, possibly in the form of a script (e.g., Python, Ruby, JavaScript, etc.). In another preferred embodiment, the instructions may include data filters or data selection criteria that define requirements for desired results sets created from the various data of the system as well as which machine learning algorithm is to be used.

Training of the machine learning techniques may be supervised, semi-supervised, or unsupervised. In some preferred embodiments, the machine learning systems may use NLP to analyze data (e.g., audio data, text data, etc.). Training of the machine learning techniques may result in baseline machine learning techniques that may serve as AI techniques for performing the various functions of the system in the manners described herein. Baseline machine learning techniques may further be configured to act as passive models or active models. A passive model may be described as a final, completed machine learning model that uses only the baseline data set to establish behavior of the baseline machine learning technique. An active model may be described as a plasticity machine learning model that is dynamic in that it may be updated using both the baseline dataset and data outside of the baseline data set.

In a preferred embodiment, the system may use a passive model to allow for a high degree of control as to how the system manages user interfaces and display windows in the manners described herein. For instance, a passive model may be configured via a private dataset to provide each user of the system with the same exercise recommendations. These recommendations may be made by the system regardless of user data that may indicate that particular users have historically preferred other dietary and exercise recommendations. A passive model may be especially useful for users having user profiles with little fitness data 430D from which the machine learning techniques may learn from. In some preferred embodiments, the system may be configured to begin as passive models until a threshold amount of user data has been acquired. Once the threshold amount of user data has been acquired, the system may cause the machine learning techniques to switch to active models, allowing the system to make recommendations to a user that better parallel historical preferences of the user. For instance, a system may be configured to make exercise recommendations to the user based on a passive model for the first 30 exercise recommendations, wherein the system may also be configured to determine if a user followed the exercise recommendations made by the system. After the system has made 30 exercise recommendations, the machine learning techniques of the system may switch to an active machine model for that particular user and make exercise recommendations based on the exercises chosen by the user after recommendations had been made by the system.

In some embodiments, an active machine model may be updated in real-time, daily, weekly, bimonthly, monthly, quarterly, or annually using the various data (e.g., to update model instructions, shifts in time, new/corrected private data sets, user data, fitness data, etc.), of the system. In some preferred embodiments, the passive machine model may also be updated as new/updated private data sets become available. In a preferred embodiment, machine learning techniques comprise metadata that describe the state of the passive/active model with respect to its updates. The metadata may include attributes describing one or more of the following: a version number, date updated, amount of new data used for the update, shifts in model parameters, convergence requirements, or other information. Because each user of the system may potentially have a unique machine learning technique associated with their user profile due to the personal nature of user data associated with each user profile, such information allows for identifying distinct passive/active models within the system that may be separately managed.

To prevent unauthorized users from accessing other user's information, the system 400 may employ a security method. As illustrated in FIG. 8, the security method of the system 400 may comprise a plurality of permission levels 800 that may grant users 405 access to user content 815, 835, 855 within the database while simultaneously denying users 405 without appropriate permission levels 800 the ability to view user content 815, 835, 855. To access the user content 815, 835, 855 stored within the database 115, users 405 may be required to make a request via a user interface 411. Access to the data within the database 115 may be granted or denied by the processor 220 based on verification of a requesting user's 805, 825, 845 permission level 800. If the requesting user's 805, 825, 845 permission level 800 is sufficient, the processor 220 may provide the requesting user 805, 825, 845 access to user content 815, 835, 855 stored within the database. Conversely, if the requesting user's 805, 825, 845 permission level 800 is insufficient, the processor 220 may deny the requesting user 805, 825, 845 access to user content 815, 835, 855 stored within the database. In an embodiment, permission levels 800 may be based on user roles 810, 830, 850 and administrator roles 870, as illustrated in FIG. 8. User roles 810, 830, 850 allow requesting users 805, 825, 845 to access user content 815, 835, 855 that a user 405 has uploaded and/or otherwise obtained through use of the system 400. Administrator roles 870 allow administrators 865 to access system 400 wide data.

In an embodiment, user roles 810, 830, 850 may be assigned to a user 405 in a way such that a requesting user 805, 825, 845 may view user profiles 430 containing user data 430A, image data 430B, application data 430C, and fitness data 430D via a user interface 411. To access the data within the database 115, a user 405 may make a user request via the user interface 411 to the processor 220. In an embodiment, the processor 220 may grant or deny the request based on the permission level 800 associated with the requesting user 805, 825, 845. Only users 405 having appropriate user roles 810, 830, 850 or administrator roles 870 may access the data within the user profiles 430. For instance, as illustrated in FIG. 8, requesting user 1 805 has permission to view user 1 content 815 and user 2 content 835 whereas requesting user 2 825 only has permission to view user 2 content 835. Alternatively, user content 815, 835, 855 may be restricted in a way such that a user may only view a limited amount of user content 815, 835, 855. For instance, requesting user 3 845 may be granted a permission level 800 that only allows them to view user 3 content 855 related to their specific interest but not user 3 content 855 related to the identity of said user 405. In the example illustrated in FIG. 8, an administrator 865 may bestow a new permission level 800 on users 405 so that it may grant them greater permissions or lesser permissions. For instance, an administrator 865 may bestow a greater permission level 800 on other users 405 so that they may view user 3's content 855 and/or any other user's content 815, 835, 855. Therefore, the permission levels 800 of the system 400 may be assigned to users 405 in various ways without departing from the inventive subject matter described herein.

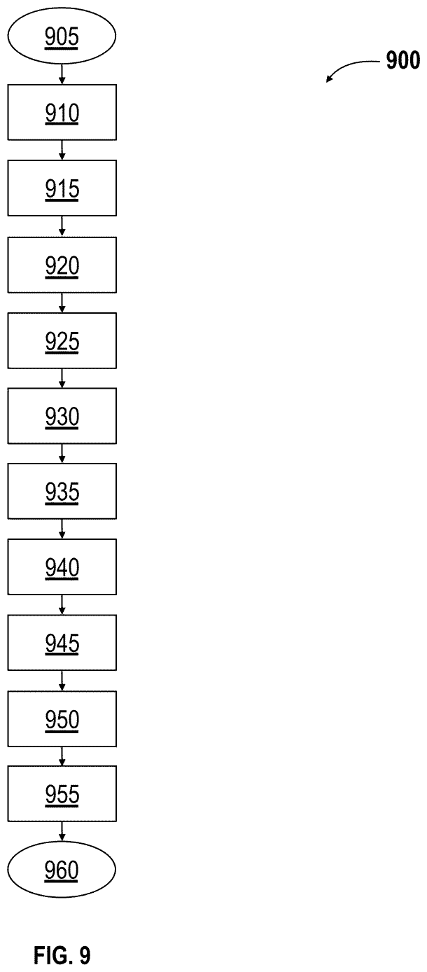

FIG. 9 illustrates a flow diagram detailing certain, preferred steps of the method 900 for providing centralized, artificial intelligence generated training instructions to a user 405. Step 905 indicates the beginning of the method. In step 910, the user device 410 is initialized and forms a connection with the server 110. In a preferred embodiment, the initialization process involves powering on the device and establishing network connectivity through available communication interfaces 280 such as Wi-Fi, cellular data, or Ethernet connections. In another preferred embodiment, the user device 410 executes a streaming client application that handles video decode capability, input transmission functionality, and sensor data relay capacity as found in the streaming-based architecture. In yet another preferred embodiment, the connection establishment includes authentication protocols to verify user credentials and device authorization before accessing the centralized database 115. The system 400 may support multiple connection types simultaneously, allowing the system 400 to automatically select the most reliable connection based on signal strength and bandwidth availability. Once the secure connection is established, the user device 410 receives initial configuration parameters from the database 115, including activity definitions, AI personality settings, and voice synthesis configurations that enable the real-time content delivery system. These configuration parameters are used to generate or retrieve the virtual environment for the training session.

During step 915, the sensors 409 are initialized to collect baseline sensor data. This baseline sensor data preferably comprises both biometric data from at least one biometric sensor and input data from at least one input device. In a preferred embodiment, the sensor initialization process involves detecting and establishing communication with external devices such as heart rate monitors, smart watches, other wearable devices, and fitness equipment sensors through the universal service provider integration system. In another preferred embodiment, the sensors 409 communicate with the user device 410 via Bluetooth, ANT+, or other wireless protocols, with the system automatically detecting available sensors without requiring manual configuration. The baseline data collection may include establishing resting heart rate, movement patterns, and environmental conditions that serve as reference points for subsequent real-time analysis and construction of a virtual model of a user 405. Alternative embodiments may support wired sensor connections or integrate directly with fitness equipment that has built-in sensing capabilities. The system stores sensor configuration parameters in the centralized database 115, enabling consistent sensor integration across different user sessions and devices. During this initialization phase, the system also calibrates sensor readings and performs diagnostic checks to ensure data accuracy and reliability.

In step 920, the baseline sensor data is transmitted to the server 110. In a preferred embodiment, the transmission process utilizes the established network connection to send collected sensor readings through secure data protocols that protect user privacy and ensure data integrity. In another preferred embodiment, the baseline data includes electronic signals encoding physiological measurements, device capabilities, and environmental parameters that are formatted according to the database schema for application logic storage. In yet another preferred embodiment, the baseline sensor data is compressed or encrypted before transmission to optimize bandwidth usage and enhance security. The system 400 may employ the multi-instance synchronization capabilities to ensure that baseline data is consistently available across all streaming instances and deployment configurations. In still another preferred embodiment, once the baseline data is successfully received and validated by the server 110, the system confirms readiness to proceed with the training session.

In step 925, the system 400 begins to process the sensor data to transform it into fitness data 430D. Generally, this process uses one or more machine learning techniques to create a virtual model of the user 405 in the virtual environment having a biometric attribute. In one preferred embodiment, the data transformation process applies the real-time application state translation layer to convert technical sensor measurements into natural language descriptions and values relative to a medical threshold that provide contextual meaning for AI coaching systems. In a preferred embodiment, the system 400 uses database-stored threshold mappings to translate numerical sensor readings into descriptive categories. For instance, a heart rate recorded by a sensor about a treadmill might be characterized as “performing at intense sprint pace” or “heart rate elevated above target zone.” Similarly, the system 400 make take raw electrical signals from a sensor or sensors and use it to generate a multifactorial model of the user's vital statistics. For instance, the system 400 could collect nIRS measurements from multiple sensors about the user to model blood flow and oxygenation status in core, cerebral, and peripheral tissues during aerobic activity. In another preferred embodiment, the processing includes filtering and validation procedures to identify anomalous readings and ensure data quality before incorporating measurements into the coaching analysis. In yet another preferred embodiment, the system 400 applies machine learning techniques to identify patterns in sensor data and generate more sophisticated interpretations of user performance trends. The transformed fitness data 430D may include not only current sensor readings but also historical context, session progress, and comparative analysis against database-stored performance targets. In still another preferred embodiment the system maintains this processed patient data in memory for immediate access by the AI coaching generation components while also logging relevant information to the database 115 for long-term analysis and personalization.

In step 930, the user 405 begins a training session. Generally, this necessitates generating or retrieving a virtual environment and using fitness data 430D to form a virtual model of a user 405 in said environment. In a preferred embodiment, the training session initiation involves querying the centralized database 115 to retrieve activity definitions, timing parameters, and performance targets that define the specific workout or training program. In another preferred embodiment, the server 110 loads database-stored mechanics including animation speeds, difficulty scaling, and threshold values that control the interactive application behavior during the session. In still another preferred embodiment, the system 400 applies the template-guided AI generation algorithm to select appropriate coaching personalities and dialogue categories based on user preferences and session context. Alternative embodiments may allow users to customize training parameters in real-time or select from multiple premade training programs stored in the database 115. In yet another preferred embodiment, the training session begins with the server 110 executing the interactive application using high-performance computing resources while streaming the rendered output to the user device 410. During session startup, the system may also initialize the context-aware AI integration pipeline to prepare for real-time coaching response generation throughout the training activity.

During step 935, the sensors 409 transmits real-time sensor data to the server 110 to update the virtual environment and the virtual model of the user 405 therein. In a preferred embodiment, the continuous data transmission process sends physiological measurements, performance metrics, and environmental readings at regular intervals determined by the sensor capabilities and application requirements. In another preferred embodiment, the real-time sensor data comprises one or more of heart rate, blood oxygenation, body temperature, caloric expenditure, movement patterns, equipment performance readings, and other biometric information that flows through the established communication channels to the server 110. In yet another preferred embodiment, the system employs buffering and error correction mechanisms to ensure reliable data delivery even when network conditions fluctuate or temporary connectivity issues occur. The system may adjust the data transmission frequency based on the intensity of the training activity or the specific requirements of different sensor types. In still another preferred embodiment, the server 110 receives and processes the incoming sensor data streams in real-time, applying the database-stored threshold parameters and response protocols to interpret the measurements. The continuous data flow enables the system to maintain up-to-date awareness of user performance and physiological state throughout the entire training session.

During step 940, the system 400 analyzes the fitness data 430 and compares it to the training activity. The analysis process involves evaluating the processed sensor information against the database-stored activity parameters, performance targets, and timing requirements that define the current training session. For instance, the system 400 could compare the intended intensity of the training program with the measured heart rate of the user 405 and suggest an augmentation or reduction in intensity according to its findings. In a preferred embodiment, the system applies the weighted content selection system to determine appropriate coaching responses based on the comparison between actual user performance and expected activity metrics. In another preferred embodiment, the analysis includes assessment of performance trends, identification of areas where the user may need encouragement or correction, and detection of safety concerns based on physiological indicators. In yet another preferred embodiment, the system 400 may incorporate predictive analytics to anticipate user needs or fatigue levels based on historical patterns and current performance trajectories. In still another preferred embodiment, the comparison process utilizes the database-driven game mechanics to adjust application behavior, visual feedback, and difficulty scaling in real-time based on the analysis results. The system 400 may also evaluate environmental factors and session context to ensure that coaching recommendations are appropriate for the current training conditions and user capabilities.

In step 945, the system generates training instructions for the user 405 based on the fitness data 430D and training activity. In a preferred embodiment, the coaching generation process employs the context-aware AI integration pipeline to create personalized guidance that responds to the user's current performance state and training requirements. In another preferred embodiment, the system uses the template-guided AI generation algorithm to combine database-stored character personalities with real-time context information, producing varied and contextually appropriate coaching dialogue. The generation process preferably includes automatic translation of technical performance metrics into conversational language that motivates and instructs the user without overwhelming them with complex data. In yet another preferred embodiment, the system 400 adjusts the coaching style, complexity, and frequency based on user preferences, experience level, or specific training objectives stored in the user profile. In still another preferred embodiment, the system 400 applies the universal service provider integration to convert the generated text into speech using the configured text-to-speech service, with voice characteristics and delivery parameters controlled through database settings. The resulting coaching audio is integrated into the streaming application output and delivered to the user device 410 as part of the real-time interactive experience. In still another preferred embodiment, the instructions take the form of illustrative drawings or animations depicting the correct method of implementing the training plan. In yet another preferred embodiment, the instructions take the form of non-linguistic, non-image-based signals indicating a particular modification. For instance, the system 400 could indicate an imminent change in rowing machine resistance with a flashing light.

In step 950, the workout is completed. The completion process involves finalizing data collection, performing session summary calculations, and preparing transition procedures to conclude the training activity. In a preferred embodiment, the system 400 captures final sensor readings, calculates performance statistics, and compares achieved results against the original training objectives stored in the database 115. In another preferred embodiment, the system 400 provides immediate feedback summaries, achievement notifications, or recommendations for subsequent training sessions based on the completed workout performance. During the completion phase, the system 400 may generate final AI coaching messages that acknowledge the user's effort and provide encouragement or suggestions for continued training progress.

During step 955, the various data are saved. In a preferred embodiment, the data preservation process involves storing session information, performance metrics, sensor readings, and user interaction data within the centralized database 115 for future reference and analysis. In another preferred embodiment, the system saves workout completion statistics, AI coaching effectiveness metrics, and sensor data patterns that contribute to the machine learning techniques used for personalization and system improvement. The saving process may include data validation, formatting according to the database schema, and integration with existing user profile information to maintain comprehensive training history records. In yet another preferred embodiment, the system 400 applies the session-based state persistence mechanisms to maintain relevant information across user sessions while clearing temporary data that is no longer needed. The system 400 may apply data compression, encryption, or selective storage policies to optimize database performance and protect user privacy while preserving essential information for system functionality. In still another preferred embodiment, the system 400 updates global content propagation records to ensure that user progress and preferences are available across all deployment instances, user computing devices 410, and streaming configurations. The data saving process preferably concludes with confirmation of successful storage and preparation of the system for subsequent training sessions or user interactions. Step 960 indicates the end of the method.

The subject matter described herein may be embodied in systems, apparatuses, methods, and/or articles depending on the desired configuration. In particular, various implementations of the subject matter described herein may be realized in digital electronic circuitry, integrated circuitry, specially designed application specific integrated circuits (ASICs), computer hardware, firmware, software, and/or combinations thereof. These various implementations may include implementation in one or more computer programs that may be executable and/or interpretable on a programmable system including at least one programmable processor, which may be special or general purpose, coupled to receive data and instructions from, and to transmit data and instructions to, a storage system, and at least one peripheral device.

These computer programs, which may also be referred to as programs, software, applications, software applications, components, or code, may include machine instructions for a programmable processor, and may be implemented in a high-level procedural and/or object-oriented programming language, and/or in assembly machine language. As used herein, the term “non-transitory computer-readable medium” refers to any computer program, product, apparatus, and/or device, such as magnetic discs, optical disks, memory, and Programmable Logic Devices (PLDs), used to provide machine instructions and/or data to a programmable processor, including a non-transitory computer-readable medium that receives machine instructions as a computer-readable signal. The term “computer-readable signal” refers to any signal used to provide machine instructions and/or data to a programmable processor. To provide for interaction with a user, the subject matter described herein may be implemented on a computer having a display device, such as a cathode ray tube (CRD), liquid crystal display (LCD), light emitting display (LED) monitor for displaying information to the user and a keyboard and a pointing device, such as a mouse or a trackball, by which the user may provide input to the computer. Displays may include, but are not limited to, visual, auditory, cutaneous, kinesthetic, olfactory, and gustatory displays, or any combination thereof.

Other kinds of devices may be used to facilitate interaction with a user as well. For instance, feedback provided to the user may be any form of sensory feedback, such as visual feedback, auditory feedback, or tactile feedback; and input from the user may be received in any form including, but not limited to, acoustic, speech, or tactile input. The subject matter described herein may be implemented in a computing system that includes a back-end component, such as a data server, or that includes a middleware component, such as an application server, or that includes a front-end component, such as a client computer having a graphical user interface or a Web browser through which a user may interact with the system described herein, or any combination of such back-end, middleware, or front-end components. The components of the system may be interconnected by any form or medium of digital data communication, such as a communication network. Examples of communication networks may include, but are not limited to, a local area network (“LAN”), a wide area network (“WAN”), metropolitan area networks (“MAN”), and the internet.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For instance, the implementations described above can be directed to various combinations and subcombinations of the disclosed features and/or combinations and subcombinations of several further features disclosed above. In addition, the logic flow depicted in the accompanying figures and/or described herein do not necessarily require the particular order shown, or sequential order, to achieve desirable results. It will be readily understood to those skilled in the art that various other changes in the details, devices, and arrangements of the parts and method stages which have been described and illustrated in order to explain the nature of this inventive subject matter can be made without departing from the principles and scope of the inventive subject matter.

What we claim is:

1) A system for automatic coaching, comprising:
a first computing device having a user interface,
wherein said user interface is configured to manage at least one permission level of a user, at least one biometric sensor operably connected to said first computing device and configured to measure biometric data of said user,
wherein said biometric data comprises information pertaining to said user's physical condition,
wherein said user interface is configured to manage said at least one biometric sensor;
at least one input device operably connected to said first computing device and configured to collect input data from said user;
wherein said user interface is configured to manage said at least one input device;
a second computing device configured to host at least one virtual environment and at least one machine learning technique,
wherein said second computing device is configured to receive said biometric data and said input data from said first computing device
a display operably connected to said first computing device and configured to display image data of said virtual world to said user;
a processor operably connected to said first computing device, second computing device, at least one sensor, and display; and
a non-transitory computer-readable medium coupled to said processor,
wherein said non-transitory computer-readable medium contains instructions stored thereon, which, when executed by said processor, cause said processor to perform operations comprising:
receiving said biometric data from said at least one biometric sensor,
receiving said input data from said at least one input device,
transforming, via a machine learning technique, said biometric data and said input data into fitness data,
wherein said fitness data comprises a virtual model of said user having at least one biometric attribute in said virtual environment,
coupling said fitness data with a training plan of said user,
generating, via said machine learning technique, training instructions based on said fitness data appropriate for improving an implementation of said training plan of said user, and
presenting said training instructions to said user via said display.

2) The system of claim 1, wherein said virtual environment is generated via an artificial intelligence technique.

3) The system of claim 1, wherein said virtual environment is prebuilt.

4) The system of claim 1, wherein said biometric data comprises at least one of heart rate data, weight data, body temperature, and blood oxygenation.

5) The system of claim 1, wherein said training plan comprises a series of physical actions undertaken by said user for the purposes of physical conditioning or physical therapy.

6) The system of claim 1, wherein said biometric data and said input data are either baseline data or real-time data.

7) The system of claim 6, wherein said machine learning technique compares said baseline data to said real-time data.

8) The system of claim 1, wherein said input data comprises information pertaining to the physical motions of said user.

9) The system of claim 1, further comprising a user profile associated with said user,
wherein said user profile organizes and associates identifying user data, image data, and said fitness data of said user,
wherein said user profile is associated with said at least one permission level.

10) The system of claim 9, further comprising additional instructions, which, when executed by said processor, cause said processor to perform additional operations comprising:
saving said fitness data of said user with said user profile of said user.

11) A method for automatic coaching, comprising the steps of:
receiving biometric data from at least one biometric sensor,
receiving input data from at least one input device,
transforming, via a machine learning technique, said biometric data and said input data into fitness data,
wherein said fitness data comprises a virtual model of a user having at least one biometric attribute in a virtual environment,
coupling said fitness data with a training plan of said user,
generating, via said machine learning technique, training instructions based on said fitness data appropriate for improving an implementation of said training plan of said user, and
presenting said training instructions to said user via a display.

12) The method of claim 11, wherein said biometric data comprises at least one of heart rate data, weight data, body temperature, and blood oxygenation.

13) The method of claim 11, wherein said training plan comprises a series of physical actions undertaken by said user for the purposes of physical conditioning or physical therapy.

14) The method of claim 11, wherein said biometric data and said input data are either baseline data or real-time data.

15) The method of claim 14, wherein said machine learning technique compares said baseline biometric data to said real-time biometric data.

16) The method claim 14, further comprising the step of adjusting, via said machine learning technique, said training plan based on said real-time data.

17) A non-transitory computer-readable medium coupled to a processor,
wherein said non-transitory computer-readable medium contains instructions stored thereon, which, when executed by said processor, cause said processor to perform operations comprising:
receiving biometric data from at least one biometric sensor,
receiving input data from at least one input device,
transforming, via a machine learning technique, said biometric data and said input data into fitness data,
wherein said fitness data comprises a virtual model of a user having at least one biometric attribute in a virtual environment,
coupling said fitness data with a training plan of said user,
generating, via said machine learning technique, training instructions based on said fitness data appropriate for improving an implementation of said training plan of said user, and
presenting said training instructions to said user via a display.

18) The non-transitory computer-readable medium of claim 17, wherein said training plan comprises a series of physical actions undertaken by said user for the purposes of physical conditioning or physical therapy.

19) The non-transitory computer-readable medium of claim 17, wherein said biometric data and said input data are either baseline data or real-time data, wherein said machine learning technique compares said baseline data to said real-time data.

20) The non-transitory computer-readable medium of claim 19, further comprising additional instructions which, when executed by said processor, cause said processor to perform additional instructions comprising adjusting, via said machine learning technique, said training plan based on said real-time data.
